(19) United States
(12) Patent Application Publication
(10) Pub. No.: US 2010/0060704 A1
(43) Pub. Date: Mar. 11, 2010

(54) LIGHT-EMITTING DEVICE, EXPOSURE DEVICE, IMAGE FORMING APPARATUS AND LIGHT-EMISSION CONTROL METHOD

(75) Inventor: Ken Tsuchiya, Kanagawa (JP)

Correspondence Address: FILDES & OUTLAND, P.C., 20916 MACK AVENUE, SUITE 2, GROSSE POINTE WOODS, MI, 48236, US

(73) Assignee: FUJI XEROX CO., LTD., Tokyo (JP)

(21) Appl. No.: 12/368,406

(22) Filed: Feb. 10, 2009

(30) Foreign Application Priority Data
Sep. 10, 2008 (JP) 2008-232150

(51) Int. Cl. B41J 2/385

(52) U.S. Cl. 347/130

(57) ABSTRACT

The light-emitting device includes: a light-emitting element array that has plural light-emitting elements arrayed in a line at intervals corresponding to a first resolution; a supply unit that supplies a light-emission signal corresponding to a second resolution, the second resolution being 1/m of the first resolution, where m is an integer not less than 2; a setting unit that divides the plural light-emitting elements into plural sets each including m continuous light-emitting elements in the light-emitting element array, and that sets whether to cause the m continuous light-emitting elements, which are included in each of the plural sets, to emit light on a single set basis by using the light-emission signal supplied from the supply unit; and a correcting unit that corrects the division of the plural light-emitting elements in the light-emitting element array performed by the setting unit, on a single light-emitting element basis.

### CROSS REFERENCE TO RELATED APPLICATIONS

This application is based on and claims priority under 35 USC §119 from Japanese Patent Application No. 2008-232150 filed Sep. 10, 2008.

### BACKGROUND

1. Technical Field

The present invention relates to a light-emitting device including plural light-emitting elements, an exposure device, an image forming apparatus and a light-emission control method.

2. Related Art

Recently, the following type of an exposure device that exposes the outer surface of an image carrier such as a photoconductor drum has been employed in an electrophotographic image forming apparatus such as a printer or a copy machine. The exposure device includes a light-emitting element array having light-emitting elements, such as light emitting diodes (LEDs), arrayed in a line. In addition, as a rapidly-increasing number of image forming apparatuses nowadays have color reproduction capabilities, an image forming apparatus capable of outputting multi-color images by using multiple image forming parts has been put into practical use. In such an image forming apparatus, the multiple image forming parts each including an exposure device are arranged in a line.

### SUMMARY

According to an aspect of the present invention, there is provided a light-emitting device including: a light-emitting element array that has plural light-emitting elements arrayed in a line at intervals corresponding to a first resolution; a supply unit that supplies a light-emission signal corresponding to a second resolution, the second resolution being 1/m of the first resolution, where m is an integer not less than 2; a setting unit that divides the plural light-emitting elements into plural sets each including m continuous light-emitting elements in the light-emitting element array, and that sets whether to cause the m continuous light-emitting elements, which are included in each of the plural sets, to emit light on a single set basis by using the light-emission signal supplied from the supply unit; and a correcting unit that corrects the division of the plural light-emitting elements in the light-emitting element array performed by the setting unit, on a single light-emitting element basis.

### BRIEF DESCRIPTION OF THE DRAWINGS

Exemplary embodiment (s) of the present invention will be described in detail based on the following figures, wherein:

FIG. 1 shows an example of an overall configuration of an image forming apparatus to which the first exemplary embodiment is applied;

FIG. 2 is a cross-sectional view of a structure of the LPH;

FIG. 3A is a top view of the circuit board and the light-emitting unit of each LPH, while FIG. 3B is a top view of the rod lens array and the holder of the LPH;

FIG. 4 is an enlarged view of a region in which the three light-emitting chips are connected in the light-emitting unit;

FIG. 5 shows a configuration of the signal generating circuit mounted on the circuit board and a wiring configuration of the circuit board;

FIG. 6 is a diagram for illustrating a circuit configuration of each of the light-emitting chips;

FIG. 7 shows an example of a configuration of the light-emission signal generating unit;

FIG. 8 shows an example in which the LPHs are mounted on the frames of the image forming apparatus, respectively;

FIGS. 9A, 9C, 9E and 9G are tables for illustrating relationships between light-emitting chip names and position correction data sets, which are stored in the position correction data memories, while FIGS. 9B, 9D, 9F and 9H are tables for illustrating relationships between light-emitting chip names and magnification correction data sets, which are stored in the magnification correction data memories;

FIGS. 10A to 10C are diagrams each for illustrating a relationship between the position correction data set and changes in luminous points in each light-emitting chip;

FIGS. 11A to 11C are diagrams each for illustrating a relationship between the magnification correction data set and changes in luminous points in each light-emitting chip;

FIG. 12 is a timing chart for illustrating how each light-emitting chip operates in the first exemplary embodiment;

FIGS. 13A to 13D show luminous points of the light-emitting chips in the LPHs;

FIGS. 14A, 14C, 14E and 14G are tables for illustrating relationships between light-emitting chip names and position correction data sets, which are stored in the position correction data memories provided in respective LPHs, while FIGS. 14B, 14D, 14F and 14H are tables for illustrating relationships between light-emitting chip names and magnification correction data sets, which are stored in the magnification correction data memories provided in respective LPHs;

FIGS. 15A to 15E are diagrams each for illustrating a relationship between the magnification correction data set and light intensities of the luminous points in each light-emitting chip caused by magnification correction;

FIGS. 16A to 16D show luminous points of the light-emitting chips in the LPHs;

FIGS. 17A to 17C are diagrams each for illustrating a relationship between the position correction data set shown and changes in luminous points in each light-emitting chip;

FIGS. 18A to 18C are diagrams each for illustrating a relationship between the magnification correction data set and changes in luminous points in each light-emitting chip; and

FIG. 19 is a timing chart for illustrating how each light-emitting chip operates in the third exemplary embodiment.

### DETAILED DESCRIPTION

Hereinafter, a detailed description will be given of exemplary embodiments of the present invention with reference to the accompanying drawings.

### First Exemplary Embodiment

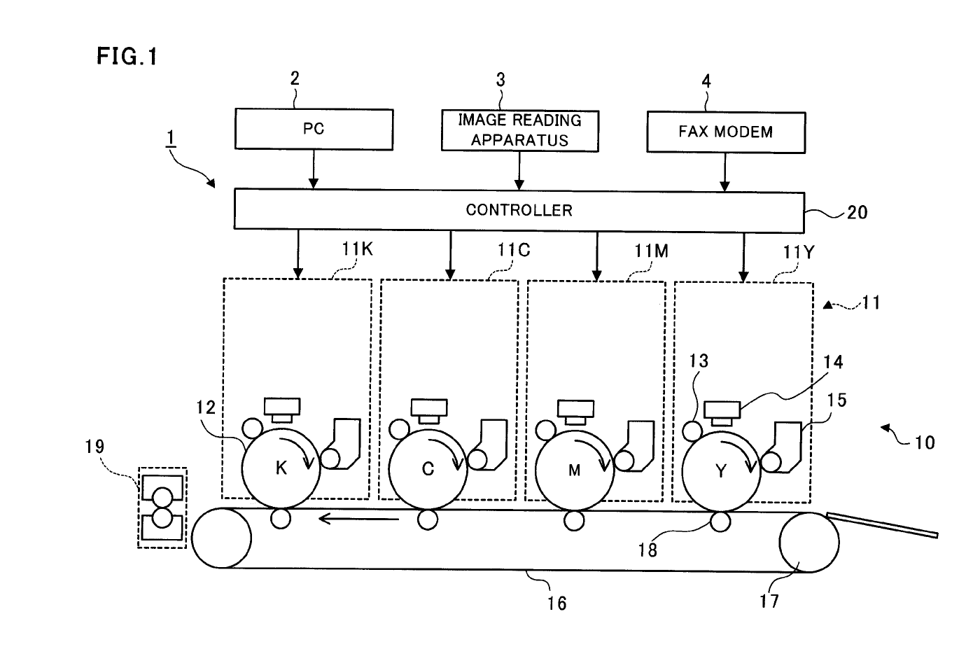

FIG. 1 shows an example of an overall configuration of an image forming apparatus 1 to which the first exemplary embodiment is applied. The image forming apparatus 1 is what is termed as a tandem image forming apparatus, and includes an image formation processing unit 10 and a controller 20. The image formation processing unit 10 forms images respectively corresponding to different color image data sets. The controller 20, which is connected to a device such as a personal computer (PC) 2, an image reading apparatus 3 or a FAX modem 4, performs image processing on image data received from the above device and controls the operations of the entire image forming apparatus 1.

The image formation processing unit 10 includes four image forming units 11 (11Y, 11M, 11C and 11K, specifically) as an example of a plurality of image forming parts. Each image forming unit 11 includes a photoconductor drum 12, a charging device 13, a LED print head (LPH) 14 and a developing device 15. The photoconductor drum 12 is an example of an image carrier. The charging device 13 as an example of a charging device charges the photoconductor drum 12. The LPH 14 as an example of an exposure device exposes the charged photoconductor drum 12 in accordance with the image data transmitted from the controller 20. The developing device 15 as an example of a developing device develops an electrostatic latent image formed on the photoconductor drum 12 with toner. In addition, the image formation processing unit 10 further includes a transport belt 16, a drive roll 17, transfer rolls 18 and a fixing device 19. The transport belt 16 transports a paper sheet on which color toner images respectively formed on the photoconductor drums 12 of the image forming units 11 are to be transferred by multilayer transfer. The drive roll 17 drives the transport belt 16. Each transfer roll 18 as an example of a transfer device transfers a toner image formed on the corresponding photoconductor drum 12 onto a paper sheet. The fixing device 19 heats and presses to fix a toner image transferred but unfixed on a paper sheet.

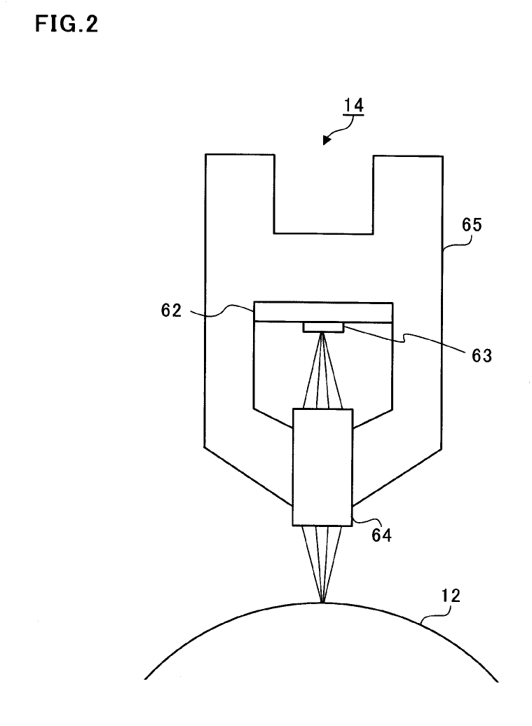

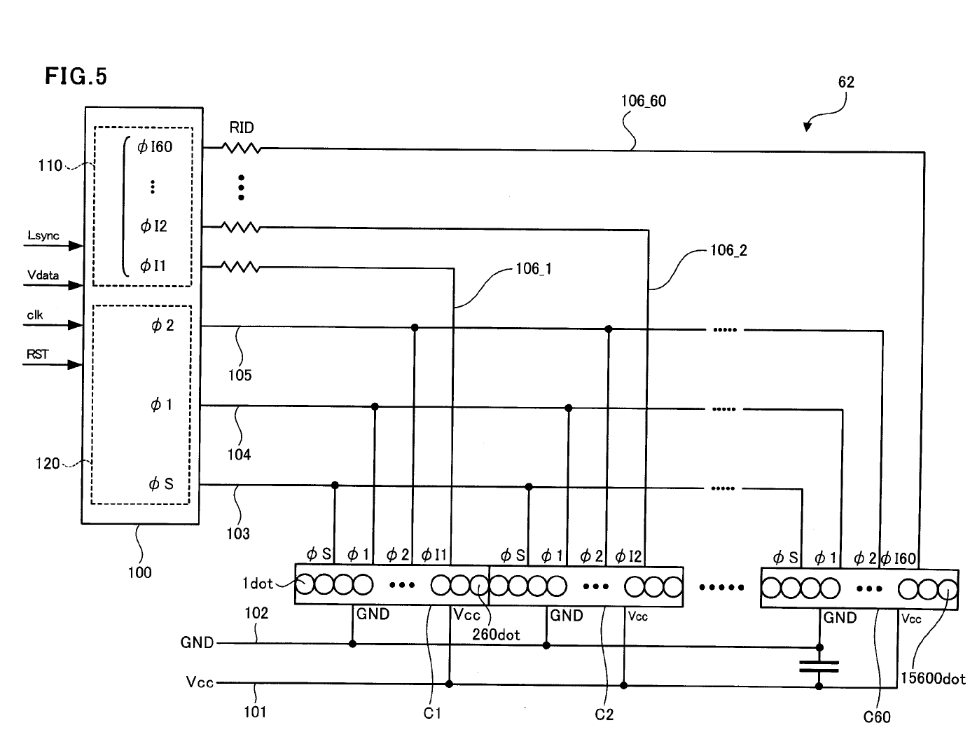

FIG. 2 is a cross-sectional view of a structure of the LPH 14. The LPH 14 includes a light-emitting unit 63, a circuit board 62, a rod lens array 64 and a holder 65. The light-emitting unit 63 includes multiple LEDs. On the circuit board 62, mounted are the light-emitting unit 63, a signal generating circuit 100 (see FIG. 5 to be described later) that drives the light-emitting unit 63, and the like. The rod lens array 64 as an example of an optical member focuses light emitted by the light-emitting unit 63 onto the outer surface of the photoconductor drum 12. The holder 65 supports the circuit board 62 and the rod lens array 64 and shields the light-emitting unit 63 from the outside.

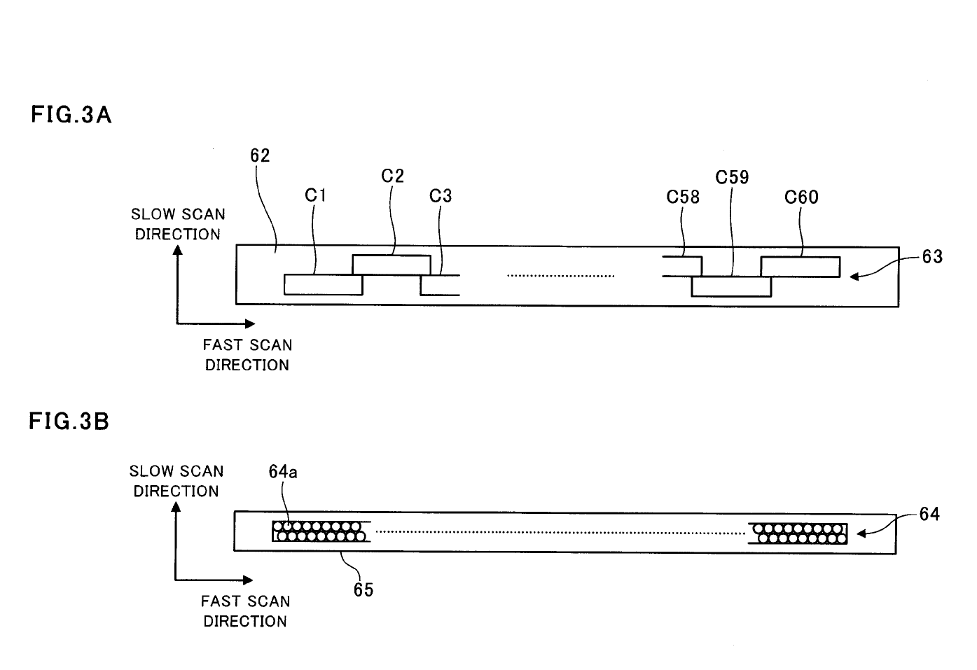

FIG. 3A is a top view of the circuit board 62 and the light-emitting unit 63 of each LPH 14, while FIG. 3B is a top view of the rod lens array 64 and the holder 65 of the LPH 14. As shown in FIG. 3A, the light-emitting unit 63 includes 60 light-emitting chips C (C1 to C60) zigzag arrayed on the circuit board 62 in two lines in a slow scan direction. Here, 60 light-emitting chips C are an example of a plurality of light-emitting element chips, while the circuit board 62 is an example of a mounting member.

Meanwhile, as shown in FIG. 3B, the rod lens array 64 includes multiple rod lenses 64a arrayed in staggered arrangement in two lines in the slow scan direction and held by the holder 65. Each rod lens 64a may be a gradient index lens having a cylindrical shape and a refractive-index distribution in the radial direction thereof to form an upright real image at the same magnification, for example. Examples of such a gradient index lens include a SELFOC (registered trademark of Nippon Sheet Glass Co., Ltd.) lens.

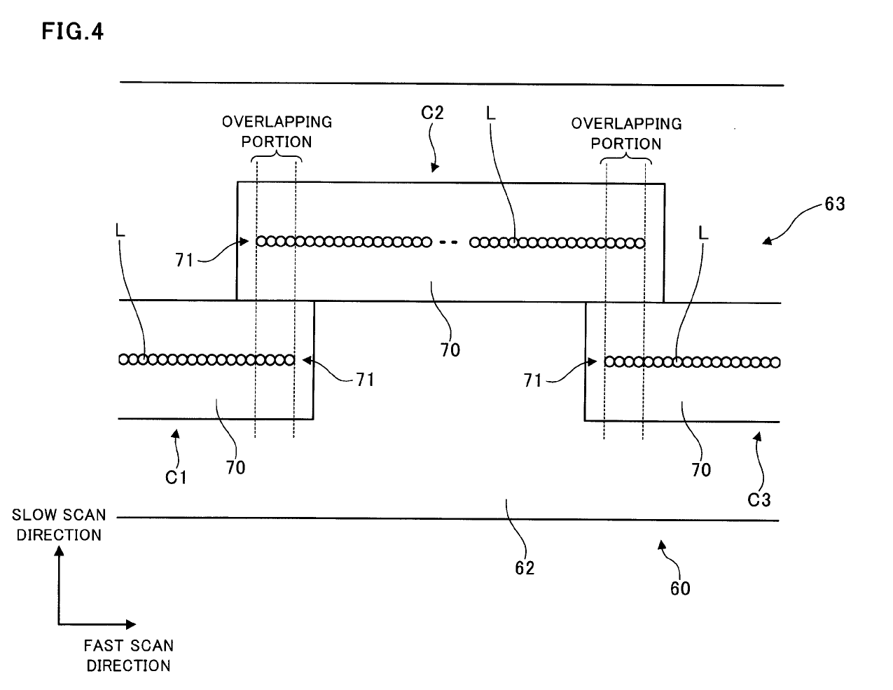

FIG. 4 is an enlarged view of a region in which the light-emitting chips C1, C2 and C3 are connected in the above light-emitting unit 63. Here, each of the light-emitting chips C1 to C60 has the same structure. Take the light-emitting chip C2 for example. It includes a chip substrate 70 and a light-emitting element array 71. The chip substrate 70 as an example of a substrate has a rectangular shape. The light-emitting element array 71 as an example of a light-emitting element array includes light-emitting elements arranged in a line extending in a longitudinal direction on the top surface of the chip substrate 70. Specifically, the light-emitting element array 71 has 260 light-emitting thyristors L as an example of multiple light-emitting elements arrayed in a line extending in a fast scan direction. In the light-emitting element array 71, a center-to-center distance between each adjacent two light-emitting thyristors L is set to approximately 21.15 μm. Accordingly, each light-emitting unit 63, that is, each LPH 14, has an output resolution (first resolution) of 1200 dot per inch (dpi) in the fast scan direction.

Moreover, as shown in FIG. 4, an overlapping portion is formed in, for example, a borderline region between the light-emitting chips C1 and C2, which are adjacent to each other. In this overlapping portion, four light-emitting thyristors L provided on a right edge portion of the light-emitting chip C1 respectively overlap four light-emitting thyristors L provided on a left edge portion of the light-emitting chip C2 in the fast scan direction. Meanwhile, an overlapping portion is also formed in, for example, a borderline region between the light-emitting chips C2 and C3, which are adjacent to each other. In this overlapping portion, four light-emitting thyristors L provided on a right edge portion of the light-emitting chip C2 respectively overlap four light-emitting thyristors L provided on a left edge portion of the light-emitting chip C3 in the fast scan direction. Note that a similar overlapping portion is formed in a borderline region between each adjacent two of the light-emitting chips C3 to C60.

FIG. 5 shows a configuration of the signal generating circuit 100 mounted on the circuit board 62 (see FIG. 2) and a wiring configuration of the circuit board 62.

The signal generating circuit 100 receives a line synchronizing signal Lsync, a video data set Vdata, a clock signal clk and various control signals such as a reset signal RST from the controller 20 (see FIG. 1). The signal generating circuit 100 includes a light-emission signal generating unit 110. On the basis of the various control signals received from the outside, the light-emission signal generating unit 110 performs processes such as sorting of contents of the video data set Vdata and correction of an output value, and outputs light-emission signals φI (φI1 to φI60) to the light-emitting chips C (C1 to C60). Note that, in the first exemplary embodiment, the light-emitting chips C (C1 to C60) are supplied with the respective light-emission signals φI (φI1 to φI60).

In addition, the signal generating circuit 100 further includes a transfer signal generating unit 120. On the basis of the various control signals received from the outside, the transfer signal generating unit 120 outputs a start transfer signal φS, a first transfer signal φ1 and a second transfer signal φ2 to each of the light-emitting chips C1 to C60.

The circuit board 62 is provided with a power supply line 101 and a power supply line 102. The power supply line 101 is a line for power supply of Vcc=−5.0 V, which is connected to Vcc terminals of the respective light-emitting chips C1 to C60. The power supply line 102 is a ground line, which is connected to GND terminals of the respective light-emitting chips C1 to C60. The circuit board 62 is also provided with a start transfer signal line 103, a first transfer signal line 104 and a second transfer signal line 105 through which the start transfer signal φS, the first transfer signal φ1 and the second transfer signal φ2 are respectively transmitted from the transfer signal generating unit 120 of the signal generating circuit 100. The circuit board 62 is also provided with 60 light-emission signal lines 106 (106_1 to 106_60) through which the light-emission signals φI (φI1 to φI60) are respectively outputted to the light-emitting chips C (C1 to C60) from the light-emission signal generating unit 110 of the signal generating circuit 100. Note that the circuit board 62 is further provided with 60 light-emission current limiting resistors RID for preventing excessive currents from flowing through the 60 light-emission signal lines 106 (106_1 to 106_60), respectively. In addition, each of the light-emission signals φI1 to φI60 may be set to either a high level H or a low level (L), to be described later. The low level corresponds to an electronic potential of −5.0 V, while the high level corresponds to an electronic potential of ±0.0 V.

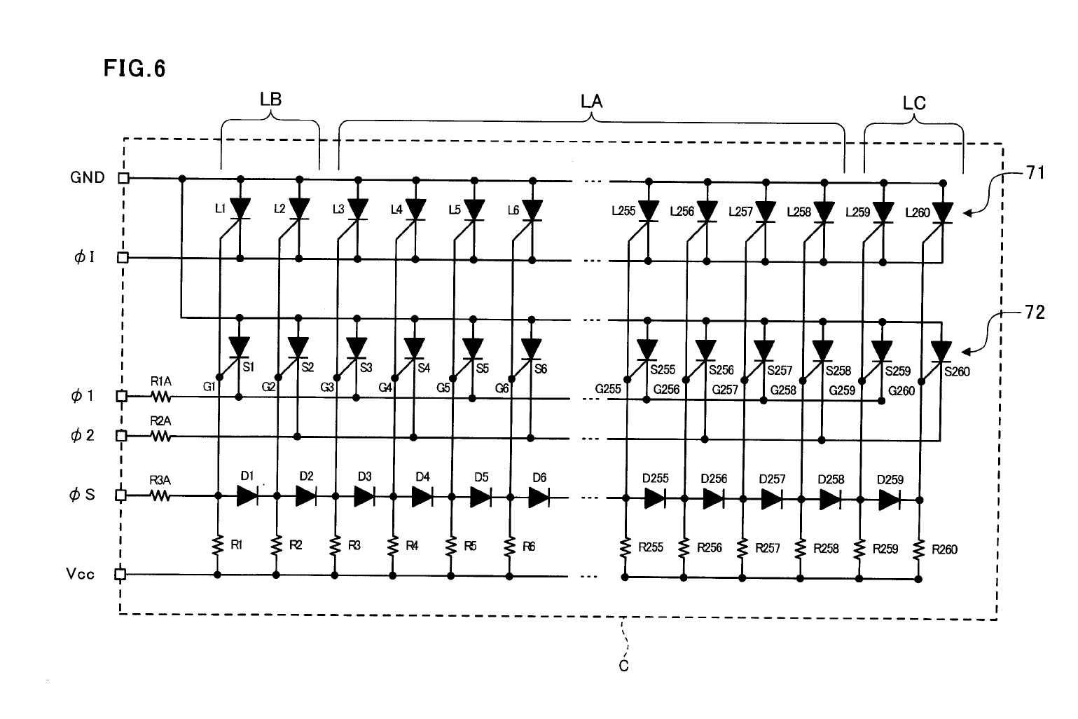

FIG. 6 is a diagram for illustrating a circuit configuration of each of the light-emitting chips C (C1 to C60).

Each light-emitting chip C includes 260 transfer thyristors S1 to S260 and 260 light-emitting thyristors L1 to L260. Note that each of the light-emitting thyristors L1 to L260 has a pnpn junction same as each of the transfer thyristors S1 to S260, and also functions as a light-emitting diode (LED) by using a pn junction in the pnpn junction. The light-emitting chip C further includes 259 diodes D1 to D259 and 260 resistors R1 to R260. The light-emitting chip C further includes transfer current limiting resistors R1A, R2A and R3A for preventing excessive currents flowing through the signal lines used for supplying the first transfer signal φ1, the second transfer signal φ2, and the start transfer signal φS. The light-emitting thyristors L1 to L260 constituting the light-emitting element array 71 are arrayed in the order of L1, L2, . . . , L259, L260 from the left of FIG. 6, and thereby form the light-emitting element array 71. Similarly, the transfer thyristors S1 to S260 are arrayed in the order of S1, S2, . . . , S259, S260 from the left of FIG. 6, and thereby form a switch element array 72. Also, the diodes D1 to D259 are arrayed in the order of D1, D2, . . . , D258, D259 from the left of FIG. 6, and the resistors R1 to R260 are arrayed in the order of R1, R2, . . . , R259, R260 from the left of FIG. 6.

Hereinafter, a description will be given of electrical connection among the elements in the light-emitting chip C.

An anode terminal of each of the transfer thyristors S1 to S260 is connected to the GND terminal. The GND terminal, to which the power supply line 102 (see FIG. 5) is connected, is grounded through the line.

A cathode terminal of each of the odd-numbered transfer thyristors S1, S3, . . . , S259 is connected to a φ1 terminal via the transfer current limiting resistor R1A. The φ1 terminal, to which the first transfer signal line 104 (see FIG. 5) is connected, is supplied with the first transfer signal φ1 through the line.

Meanwhile, a cathode terminal of each of the even-numbered transfer thyristors S2, S4, . . . , S260 is connected to a φp2 terminal via the transfer current limiting resistor R2A. The φ2 terminal, to which the second transfer signal line 105 (see FIG. 5) is connected, is supplied with the second transfer signal φ2 through the line.

Gate terminals G1 to G260 of the transfer thyristors S1 to S260 are connected to the Vcc terminal via the resistors R1 to R260 which are provided for the respective transfer thyristors S1 to S260, respectively. The Vcc terminal, to which the power supply line 101 (see FIG. 5) is connected, is provided with a power supply voltage Vcc (−5.0 V) through the line.

The gate terminals G1 to G260 of the transfer thyristors S1 to S260 are further connected to gate terminals of the light-emitting thyristors L1 to L260, respectively. Specifically, each transfer thyristor is connected to the corresponding light-emitting thyristor, which labeled with the same number as the transfer thyristor, on the one to one basis.

In addition, anode terminals of the diodes D1 to D259 are connected to the gate terminals G1 to G259 of the transfer thyristors S1 to S259, respectively. Moreover, each cathode terminal of these diodes D1 to D259 is connected to an adjacent one of the gate terminal G2 to G260 of the transfer thyristors S2 to S260 that is labeled with a number larger by one than a number labeled for the diode. In other words, the diodes D1 to D259 are connected in series while one of the gate terminals G2 to G259 of the transfer thyristors S1 to S260 are interposed between each adjacent two diodes.

The anode terminal of the diode D1, that is, the gate terminal G1 of the transfer thyristor S1 are connected to a φS terminal via the transfer current limiting resistor R3A. The φS terminal is supplied with the start transfer signal φS through the start transfer signal line 103 (see FIG. 5).

Meanwhile, an anode terminal of each of the light-emitting thyristors L1 to L260 is connected to the GND terminal, similar to the anode terminal of each of the transfer thyristors S1 to S260.

A cathode terminal of each of the light-emitting thyristors L1 to L260 is connected to a φI terminal. The φI terminal, to which the light-emission signal line 106 (the light-emission signal line 106_1 for the light-emitting chip C1: see FIG. 5) is connected, is supplied with the light-emission signal φI (the light-emission signal φI1 for the light-emitting chip C1) through the line. Note that, the other light-emitting chips C2 to C60 are supplied with the corresponding light-emission signals φI2 to φI60, respectively.

Here, as the light-emitting unit 63 is formed, the four light-emitting thyristors L1 to L4 provided on a left side of FIG. 6 and the four light-emitting thyristors L257 to L260 provided on a right side of FIG. 6 in each light-emitting chip C constitute overlapping portions shown in FIG. 4.

Note that, each light-emitting chip C has the 260 light-emitting thyristors L1 to L260 in total as described above. However, each light-emitting chip C uses light-emitting thyristors less than the total 260 light-emitting thyristors, as luminous points in an actual image forming operation. Here, the “luminous point” indicates a light-emitting thyristor L that is caused to emit light or not to emit light in an image forming operation (exposure operation). To be more specific, the 256 light-emitting thyristors L3 to L258, which are consecutively provided in a center portion, are normally used as luminous points. However, depending on a result of position correction in the fast scan direction to be described later, the 256 consecutive light-emitting thyristors including either the light-emitting thyristor L2, provided on the left side of FIG. 6, or the light-emitting thyristor L259, provided on the right side of FIG. 6, may sometimes be used as luminous points. Meanwhile, depending on a result of magnification correction in the fast scan direction to be described later, the 255 or 257 consecutive light-emitting thyristors may sometimes be used as luminous points. Moreover, depending on a result of these position correction and magnification correction in the fast scan direction, the 257 consecutive light-emitting thyristors including either the light-emitting thyristors L1 and L2, provided on the left side of FIG. 6, or the light-emitting thyristors L259 and L260, provided on the right side of FIG. 6, may sometimes be used as luminous points.

However, in the overlapping portion of each adjacent two light-emitting chips C (for example, the light-emitting chips C1 and C2), any one of each two light-emitting thyristors provided at the same point in the fast scan direction is used as a luminous point, but the other is not. (For example, in the overlapping portion of the light-emitting chips C1 and C2, any one of the light-emitting thyristor L258 of the light-emitting chip C1 and the light-emitting thyristor L2 of the light-emitting chip C2 is used as a luminous point, but the other is not.) Note that, in the following description, among the light-emitting thyristors L1 to L260 constituting each light-emitting chip C, a light-emitting thyristor L that is not used as a luminous point will be referred to as a “non-luminous point.”

Moreover, in the following description, the 256 light-emitting thyristors L3 to L258 provided in the center portion of each light-emitting chip C are collectively referred to as a normal luminous-point group LA. Meanwhile, the two light-emitting thyristors L1 and L2 provided in a leftmost portion of the light-emitting chip C are collectively referred to as a first standby luminous-point group LB, and the two light-emitting thyristors L259 and L260 provided in a rightmost portion of the light-emitting chip C are collectively referred to as a second standby luminous-point group LC. Here, the normal luminous-point group LA, the first standby luminous-point group LB and the second standby luminous-point group LC are equivalent to a first light-emitting element group, a second light-emitting element group and a third light-emitting element group, respectively.

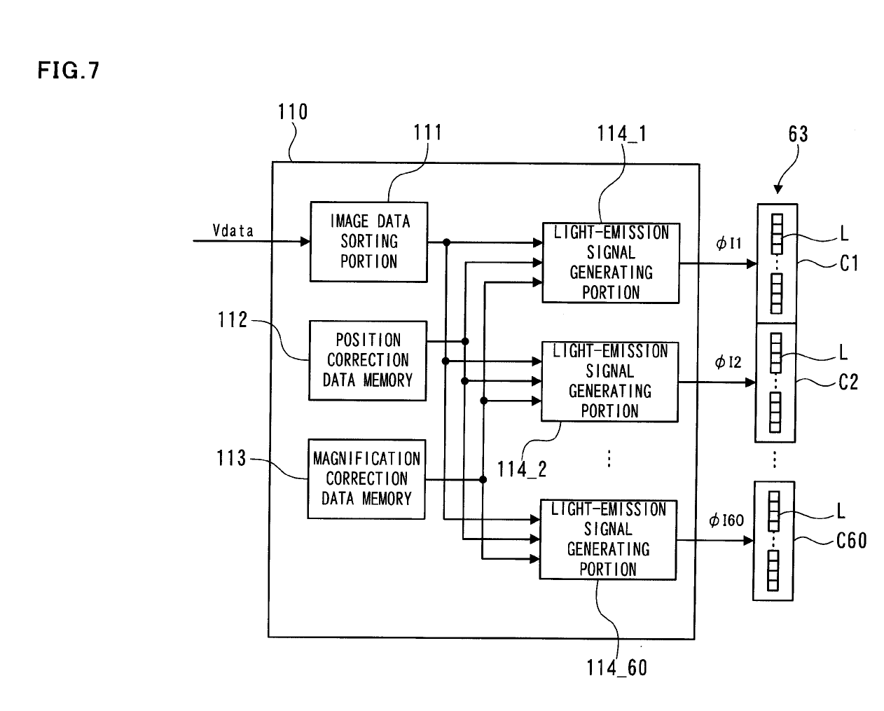

FIG. 7 shows an example of a configuration of the light-emission signal generating unit 110 shown in FIG. 5.

The light-emission signal generating unit 110 includes an image data sorting portion 111. The image data sorting portion 111 sorts contents of received video data set Vdata, and outputs, to the light-emitting chips C1 to C60, different image data sets dedicated thereto, respectively. The light-emission signal generating unit 110 further includes a position correction data memory 112 and a magnification correction data memory 113. The position correction data memory 112 stores therein data sets on position correction in the fast scan direction predefined for the respective light-emitting chips C1 to C60. The magnification correction data memory 113 stores therein data sets on magnification correction in the fast scan direction predefined for the respective light-emitting chips C1 to C60. Moreover, the light-emission signal generating unit 110 further includes 60 light-emission signal generating portions 114 (114_1 to 114_60) provided for the respective light-emitting chips C1 to C60. Each light-emission signal generating portion 114 performs the following two corrections on the image data set dedicated to the corresponding light-emitting chip, which is inputted from the image data sorting portion 111: one is performed by using the position correction data set dedicated to this light-emitting chip, which is read out from the position correction data memory 112; the other is performed by using the magnification correction data set dedicated to the light-emitting chip, which is read out from the magnification correction data memory 113. Thereafter, the light-emission signal generating portions 114_1 to 114_60 output the respective light-emission signals φI1 to φI60 obtained through these corrections. Note that, in the first exemplary embodiment, the light-emission signal generating portions 114 (114_1 to 114_60) each function as a supply unit, a setting unit and a correcting unit as well as correctively function as a supply section and a correcting section.

Note that, though the light-emitting unit 63 constituting each LPH 14 has an output resolution of 1200 dpi in the fast scan direction as described above, the video data set Vdata inputted into the light-emission signal generating unit 110 has a resolution (second resolution) of 600 dpi in the fast scan direction in the first exemplary embodiment. In other words, the resolution of the light-emission signal generating unit 110 is half (½) of the output resolution of the LPH 14. Accordingly, in the first exemplary embodiment, a new twist is added to the method in which the light-emission signal generating portions 114 (114_1 to 114_60) generate the respective light-emission signals φI (φI1 to φI60), in order to operate the light-emitting unit 63 with an output resolution of approximately 600 dpi. This is achieved by causing each of the light-emitting chips C (C1 to C60), which correspond to the respective light-emission signal generating portions 114, to drive basically a pair of two adjacent light-emitting thyristors L. A detailed description thereof will be described later.

Hereinbelow, a description will be given of position correction and magnification correction in the fast scan direction performed in each LPH 14.

In the first exemplary embodiment, an image is formed by using the four image forming units 11 (11Y, 11M, 11C, 11K) in the image forming apparatus 1 as described with reference to FIG. 1. Accordingly, the LPHs 14 are provided for these respective colors. However, the accuracy limitations of a frame of the image forming apparatus 1 to which each LPH 14 is mounted and of the LPH 14 itself make it difficult to mount the LPHs 14 to the image forming apparatus 1 so that the positions of the LPHs 14 are aligned with respect to the image forming apparatus 1 in the fast scan direction. Thus, in this image forming apparatus 1, position correction in the fast scan direction is performed in order to accurately align light beams emitted by the respective LPHs 14 in the fast scan direction. Note that, in the following description, the position correction in the fast scan direction will be simply referred to as position correction.

In addition, there also are limitations on mounting accuracy of the light-emitting chips C to each LPH 14 and on forming accuracy of the light-emitting thyristors L in each light-emitting chip C, and these limitations make it difficult to make the lengths of the light-emitting thyristor arrays provided in the respective LPHs 14 equal to one another. Thus, in this image forming apparatus 1, magnification correction in the fast scan direction is performed in order to accurately make light beams emitted by the respective LPHs 14 have an equal length in the fast scan direction. Note that, in the following description, the magnification correction in the fast scan direction will be simply referred to as magnification correction.

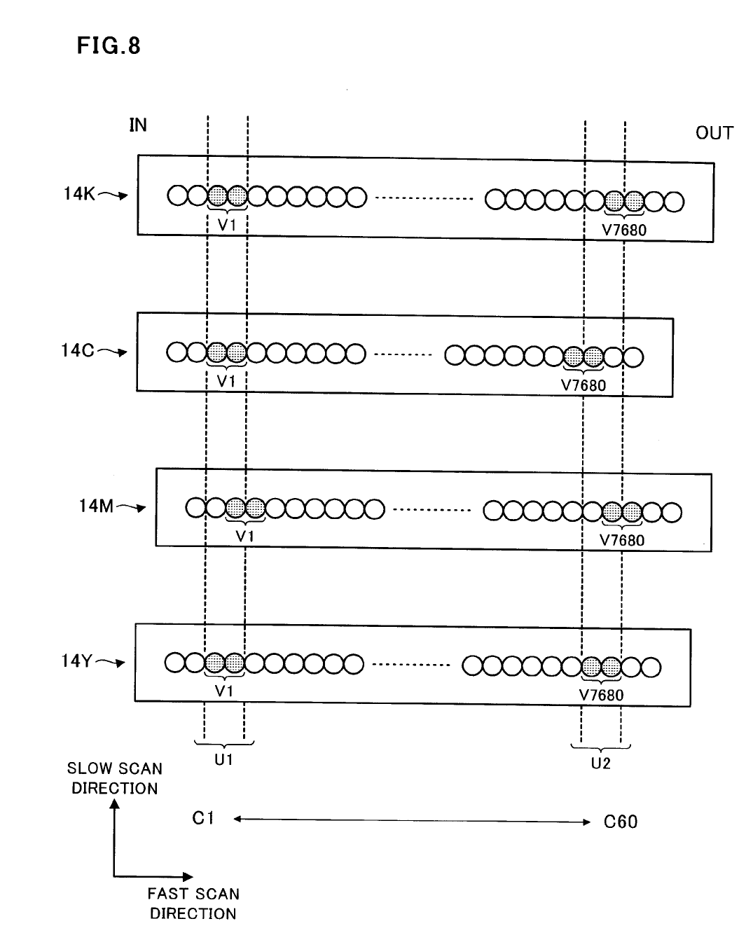

FIG. 8 shows an example in which the LPHs 14 (14Y, 14M, 14C and 14K, specifically) constituting the image forming units 11 (11Y, 11M, 11C and 11K, specifically) are mounted on the unillustrated frames of the image forming apparatus 1, respectively. Note that, the left and right sides of FIG. 8 respectively correspond to the front (IN) and back (OUT) sides of the image forming apparatus 1 shown in FIG. 1. Incidentally, the position correction and magnification correction described above are performed by using any one of the LPHs 14 as the reference. The following description will be given of the case where position correction and magnification correction are performed on each of the magenta LPH 14M, the cyan LPH 14C and the black LPH 14K by using the yellow LPH 14Y as the reference.

Note that, in the initial condition before these position correction and magnification correction are performed, the normal luminous-point group LA (light-emitting thyristors L3 to L258) are set as luminous points in each of the light-emitting chips C (C1 to C60) of the LPHs 14. Thus, the first luminous point, which lies at the IN-side end of each LPH 14, is the light-emitting thyristor L3 (see FIG. 6) of the light-emitting chip C1, while the 15360-th luminous point, which lies at the OUT-side end of each LPH 14, is the light-emitting thyristor L258 (see FIG. 6) of the light-emitting chip C60.

In addition, in the first exemplary embodiment, each pixel of an image is formed basically of two luminous points so that the LPHs 14 each having an output resolution of 1200 dpi in the fast scan direction is used to output 600 dpi data as described above. Thus, the initial condition includes the settings where the light-emitting thyristors L3 and L4 (first and second luminous points: see FIG. 6) of each light-emitting chip C1 is used to form a first pixel V1, and where the light-emitting thyristors L257 and L258 (15359-th and 15360-th luminous points: see FIG. 6) of each light-emitting chip C60 is used to form a 7680-th pixel V7680. Here, assume that the positions of the first pixel V1 and the 7680-th pixel V7680 in the fast scan direction in the yellow LPH 14Y are a first reference position U1 and a second reference position U2, respectively.

Then, in the magenta LPH 14M, the position of the first pixel V1 in the fast scan direction shifts to the OUT side by 0.5 pixel (one luminous point) with respect to the first reference position U1, and the position of the 7680-th pixel V7680 in the fast scan direction shifts to the OUT side by 0.5 pixel (one luminous point) with respect to the second reference position U2. Accordingly, the magenta LPH 14M exhibits a positional shift of 0.5 pixel to the OUT side in the fast scan direction with respect to the yellow LPH 14Y. Such a positional shift will be referred to as OUT-side positional shift in the following description.

Note that, here, a description has been given to the case where positional shift occurs to the OUT side in the fast scan direction. However, the contrary case may occur where the position of the first pixel V1 in the fast scan direction shifts to the IN side by 0.5 pixel (one luminous point) with respect to the first reference position U1, and the position of the 7680-th pixel V7680 in the fast scan direction shifts to the IN side by 0.5 pixel (one luminous point) with respect to the second reference position U2, so that a positional shift of 0.5 pixel occurs to the IN side in the fast scan direction. Such a positional shift will be referred to as IN-side positional shift in the following description.

Meanwhile, in the cyan LPH 14C, the position of the first pixel V1 in the fast scan direction does not shift with respect to the first reference position U1, but the position of the 7680-th pixel V7680 in the fast scan direction shifts to the IN side by 0.5 pixel (one luminous point) with respect to the second reference position U2. Accordingly, the cyan LPH 14C has a length difference (magnification deviation) of being shorter by 0.5 pixel in the fast scan direction than the yellow LPH 14Y. Such a magnification deviation will be referred to as size-reduction deviation in the following description.

On the other hand, in the black LPH 14K, the position of the first pixel V1 in the fast scan direction does not shift with respect to the first reference position U1, but the position of the 7680-th pixel V7680 in the fast scan direction shifts to the OUT side by 0.5 pixel (one luminous point) with respect to the second reference position U2. Accordingly, the black LPH 14K has a length difference (magnification deviation) of being longer by 0.5 pixel in the fast scan direction than the yellow LPH 14Y. Such a magnification deviation will be referred to as size-enlargement deviation in the following description.

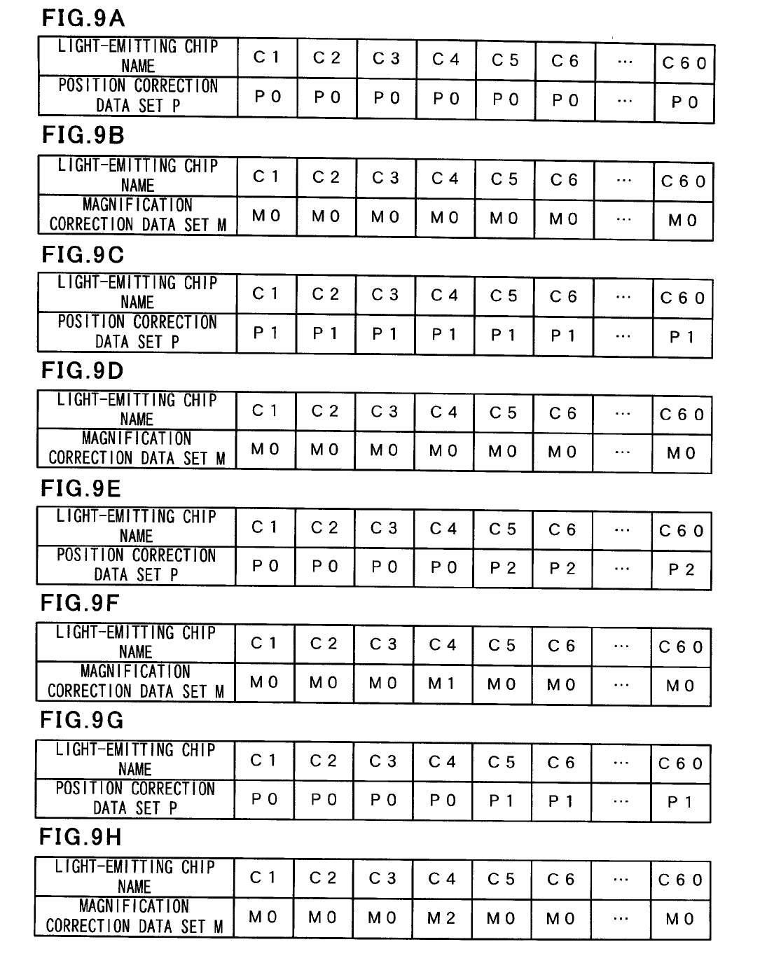

FIGS. 9A, 9C, 9E and 9G are tables for illustrating relationships between light-emitting chip names and position correction data sets P, which are stored in the position correction data memories 112 (see FIG. 7), while FIGS. 9B, 9D, 9F and 9H are tables for illustrating relationships between light-emitting chip names and magnification correction data sets M, which are stored in the magnification correction data memories 113 (see FIG. 7). Here, the position correction data memory 112 and the magnification correction data memory 113 are provided in each LPH 14 as described above. FIGS. 9A to 9H show various correction data sets to be set when the yellow LPH 14Y, the magenta LPH 14M, the cyan LPH 14C and the black LPH 14K are mounted in the image forming apparatus 1 in the condition shown in FIG. 8. Note that the position correction data set P and the magnification correction data set M for each light-emitting chip C is acquired as factory default, for example, and respectively stored in the position correction data memory 112 and the magnification correction data memory 113 of the corresponding LPH 14.

Here, FIGS. 9A and 9B show contents stored in the position correction data memory 112 and the magnification correction data memory 113 of the yellow LPH 14Y, respectively. FIGS. 9C and 9D show contents stored in the position correction data memory 112 and the magnification correction data memory 113 of the magenta LPH 14M, respectively. FIGS. 9E and 9F show contents stored in the position correction data memory 112 and the magnification correction data memory 113 of the cyan LPH 14C, respectively. FIGS. 9G and 9H show contents stored in the position correction data memory 112 and the magnification correction data memory 113 of the black LPH 14K, respectively.

As shown in FIG. 9A, in the position correction data memory 112 of the yellow LPH 14Y, a reference position correction data set P0 is set as each of the position correction data sets P for the respective light-emitting chips C1 to C60. Meanwhile, as shown in FIG. 9B, in the magnification correction data memory 113 of the yellow LPH 14Y, a reference magnification correction data set MO is set as each of the magnification correction data sets M for the respective light-emitting chips C1 to C60.

As shown in FIG. 9C, in the position correction data memory 112 of the magenta LPH 14M, a first position correction data set P1 is set as each of the position correction data sets P for the respective light-emitting chips C1 to C60. Meanwhile, as shown in FIG. 9D, in the magnification correction data memory 113 of the magenta LPH 14M, the reference magnification correction data set M0 is set as each of the magnification correction data sets M for the respective light-emitting chips C1 to C60.

As shown in FIG. 9E, in the position correction data memory 112 of the cyan LPH 14C, the reference position correction data set P0 is set as each of the position correction data sets P for the respective light-emitting chips C1 to C4, and a second position correction data set P2 is set as each of the position correction data sets P for the respective light-emitting chips C5 to C60. Meanwhile, as shown in FIG. 9F, in the magnification correction data memory 113 of the cyan LPH 14C, the reference magnification correction data set M0 is set as each of the magnification correction data sets M for the respective light-emitting chips C1 to C3 and C5 to C60, and a first magnification correction data set M1 is set as the magnification correction data set M for the light-emitting chip C4.

As shown in FIG. 9G, in the position correction data memory 112 of the black LPH 14K, the reference position correction data set P0 is set as each of the position correction data sets P for the respective light-emitting chips C1 to C4, and the first position correction data set P1 is set as each of the position correction data sets P for the respective light-emitting chips C5 to C60. Meanwhile, as shown in FIG. 9H, in the magnification correction data memory 113 of the black LPH 14K, the reference magnification correction data set M0 is set as each of the magnification correction data sets M for the respective light-emitting chips C1 to C3 and C5 to C60, and a second magnification correction data set M2 is set as the magnification correction data set M for the light-emitting chip C4.

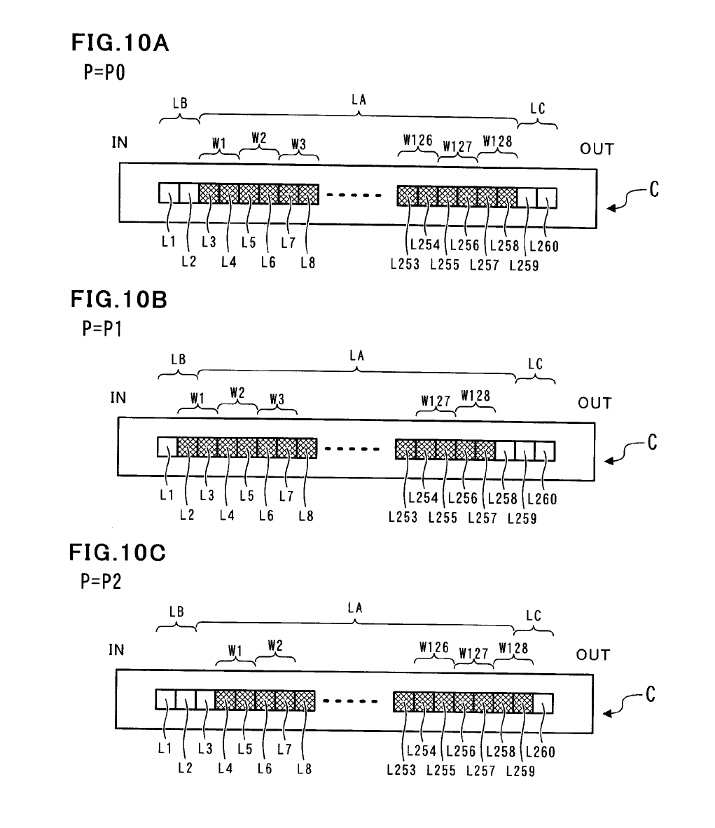

FIGS. 10A to 10C are diagrams each for illustrating a relationship between the position correction data set P and changes in luminous points in each light-emitting chip C caused by position correction. As described above, the position correction data set P may be the reference position correction data set P0, the first position correction data set P1 or the second position correction data set P2. Here, FIGS. 10A to 10C show the cases of P=P0, P=P1 and P=P2, respectively.

As shown in FIG. 10A, with P=P0, the normal luminous-point group LA, that is, the light-emitting thyristors L3 to L258 remain set as the luminous points in the light-emitting chip C. As a result, the light-emitting chip C forms 128 pixels W1 to W128 by using the 256 light-emitting thyristors L3 to L258. In this event, each of the pixels W1 to W128 is formed of an odd-numbered light-emitting thyristor and an even-numbered light-emitting thyristor that is adjacent to the right side of the odd-numbered light-emitting thyristor. Specifically, the pixel W1 on the left side of FIG. 10A is formed of the light-emitting thyristors L3 and L4, while the pixel W128 on the right side of FIG. 10A is formed of the light-emitting thyristors L257 and L258, for example.

By contrast, as shown in FIG. 10B, with P=P1, all the light-emitting thyristors of the normal luminous-point group LA except the light-emitting thyristor L258, and the second light-emitting thyristor L2 of the first standby luminous-point group LB are set as the luminous points in the light-emitting chip C. In other words, the luminous points in the light-emitting chip C are set to the light-emitting thyristors L2 to L257, and thus the luminous points shift by one to the IN side. As a result, the light-emitting chip C forms the 128 pixels W1 to W128 by using the 256 light-emitting thyristors L2 to L257. In this event, each of the pixels W1 to W128 is formed of an even-numbered light-emitting thyristor and an odd-numbered light-emitting thyristor that is adjacent to the right side of the even-numbered light-emitting thyristor. Specifically, the pixel W1 on the left side of FIG. 10B is formed of the light-emitting thyristors L2 and L3, while the pixel W128 on the right side of FIG. 10B is formed of the light-emitting thyristors L256 and L257, for example.

On the other hand, as shown in FIG. 10C, with P=P2, all the light-emitting thyristors of the normal luminous-point group LA except the light-emitting thyristor L3, and the 259-th light-emitting thyristor L259 of the second standby luminous-point group LC are set as the luminous points in the light-emitting chip C. In other words, the luminous points in the light-emitting chip C are set to the light-emitting thyristors L4 to L259, and thus the luminous points shift by one to the OUT side. As a result, the light-emitting chip C forms the 128 pixels W1 to W128 by using the 256 light-emitting thyristors L4 to L259. In this event, each of the pixels W1 to W128 is formed of an even-numbered light-emitting thyristor and an odd-numbered light-emitting thyristor that is adjacent to the right side of the even-numbered light-emitting thyristor. Specifically, the pixel W1 on the left side of FIG. 10C is formed of the light-emitting thyristors L4 and L5, while the pixel W128 on the right side of FIG. 10C is formed of the light-emitting thyristors L258 and L259, for example.

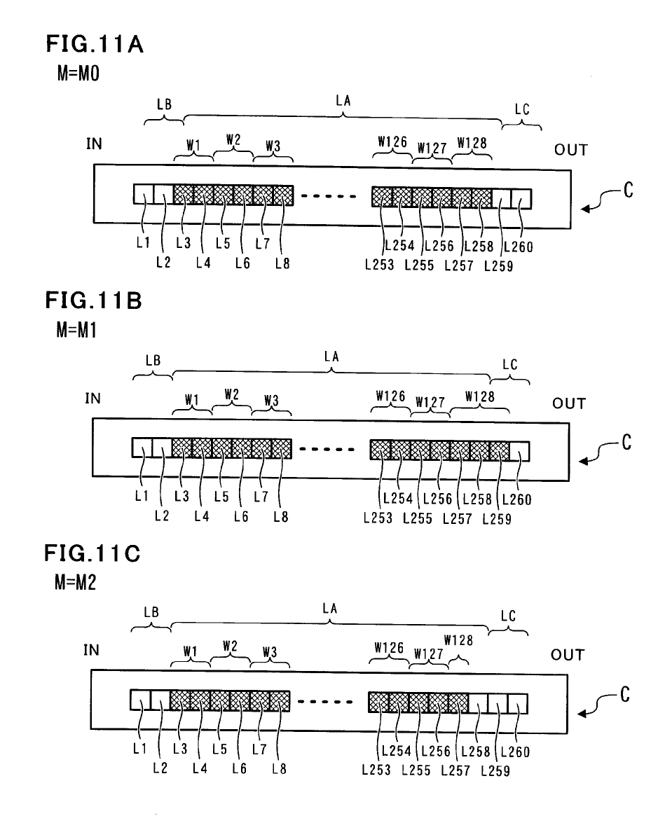

FIGS. 11A to 11C are diagrams each for illustrating a relationship between the magnification correction data set M and changes in luminous points in each light-emitting chip C caused by magnification correction. As described above, the magnification correction data set M may be the reference magnification correction data set M0, the first magnification correction data set M1 or the second magnification correction data set M2. Here, FIGS. 11A to 11C show the cases of M=M0, M=M1 and M=M2, respectively.

As shown in FIG. 11A, with M=M0, the normal luminous-point group LA, that is, the light-emitting thyristors L3 to L258 remain set as the luminous points in the light-emitting chip C. As a result, the light-emitting chip C forms 128 pixels W1 to W128 by using the 256 light-emitting thyristors L3 to L258. In this event, each of the pixels W1 to W128 is formed of an odd-numbered light-emitting thyristor and an even-numbered light-emitting thyristor that is adjacent to the right side of the odd-numbered light-emitting thyristor. Specifically, the pixel W1 on the left side of FIG. 11A is formed of the light-emitting thyristors L3 and L4, while the pixel W128 on the right side of FIG. 11A is formed of the light-emitting thyristors L257 and L258, for example.

By contrast, as shown in FIG. 11B, with M=M1, all the light-emitting thyristors of the normal luminous-point group LA and the 259-th light-emitting thyristor L259 of the second standby luminous-point group LC are set as the luminous points in the light-emitting chip C. In other words, the luminous points in the light-emitting chip C are set to the light-emitting thyristors L3 to L259, and thus the luminous points increases by one on the right side of FIG. 11B (on the OUT side in FIG. 8). As a result, the light-emitting chip C forms the 128 pixels W1 to W128 by using the 257 light-emitting thyristors L3 to L259. In this event, each of the pixels W1 to W127 is formed of an odd-numbered light-emitting thyristor and an even-numbered light-emitting thyristor that is adjacent to the right side of the odd-numbered light-emitting thyristor. Specifically, the pixel W1 on the left side of FIG. 11B is formed of the light-emitting thyristors L3 and L4, while the pixel W127 on the right side of FIG. 11B is formed of the light-emitting thyristors L255 and L256, for example. Meanwhile, the pixel W128 on the right side of FIG. 11B is formed of three luminous points, that is, the odd-numbered light-emitting thyristor L257, the even-numbered light-emitting thyristor L258 that is adjacent to the right side of the light-emitting thyristor L257, and the odd-numbered light-emitting thyristor L259 that is adjacent to the right side of the light-emitting thyristor L258.

On the other hand, as shown in FIG. 11C, with M=M2, all the light-emitting thyristors of the normal luminous-point group LA except the light-emitting thyristor L258 are set as the luminous points in the light-emitting chip C. In other words, the luminous points in the light-emitting chip C are set to the light-emitting thyristors L3 to L257, and thus the luminous points decreases by one on the right side of FIG. 11C (on the OUT side in FIG. 8). As a result, the light-emitting chip C forms the 128 pixels W1 to W128 by using the 255 light-emitting thyristors L3 to L257. In this event, each of the pixels W1 to W127 is formed of an odd-numbered light-emitting thyristor and an even-numbered light-emitting thyristor that is adjacent to the right side of the odd-numbered light-emitting thyristor. Specifically, the pixel W1 on the left side of FIG. 11C is formed of the light-emitting thyristors L3 and L4, while the pixel W127 on the right side of FIG. 11C is formed of the light-emitting thyristors L255 and L256, for example. Meanwhile, the pixel W128 on the right side of FIG. 11C is formed of one luminous point, that is, only the odd-numbered light-emitting thyristor L257.

Hereinbelow, a description will be given of the exposure operation performed by each LPH 14 of the image forming apparatus 1 shown in FIG. 1.

Upon start of the image forming operation, the controller 20 transmits video data sets Vdata to the signal generating circuits 100 of the LPHs 14 constituting the image forming units 11, respectively. In response, in the signal generating circuit 100 provided in each LPH 14, the transfer signal generating unit 120 outputs, to 60 light-emitting chips C (C1 to C60) constituting the light-emitting unit 63, the start transfer signal φS, the first transfer signal φ1 and the second transfer signal φ2, which are generated on the basis of the received control signals and the like. In addition, in the signal generating circuit 100, the light-emission signal generating unit 110 outputs the 60 light-emission signals φI (φI1 to φI60) to the respective 60 light-emitting chips C (C1 to C60) constituting the light-emitting unit 63. Here, the light-emission signals φI1 to φI60 correspond to one line in the fast scan direction and are generated on the basis of the received video data sets Vdata. In response, in the light-emitting unit 63 of each LPH 14, each of the light-emitting chips C1 to C60 causes its light-emitting thyristors L1 to L260 independently to emit light or not to emit light in accordance with the received one of the light-emission signals φI1 to φI60, and thereby selectively exposes the corresponding photoconductor drum 12. Note that, in this event, each of the light-emitting chips C1 to C60 sets its light-emitting thyristors L1 to L260 as follows. Specifically, the light-emitting chip C causes each of the light-emitting thyristors L that are set as luminous points either to emit light or not to emit light, while causes each of the light-emitting thyristors L that are set as non-luminous points not to emit light.

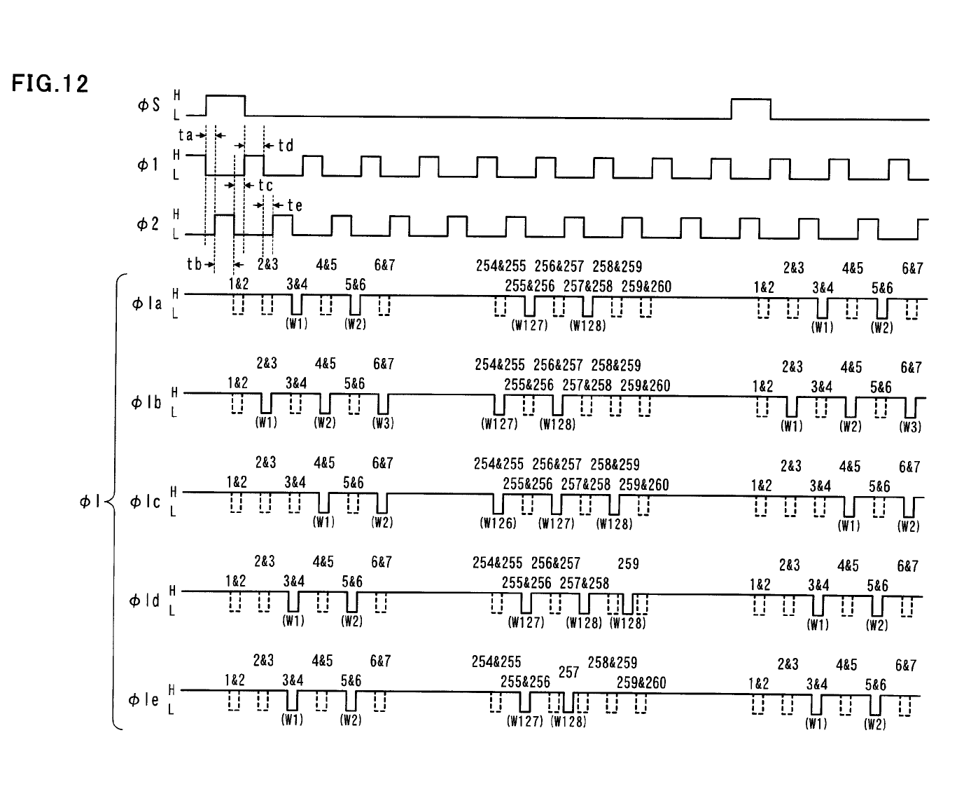

Next, a detailed description will be given of how each light-emitting chip C operates during this exposure operation with reference to a timing chart shown in FIG. 12. Note that, in FIG. 12, a first light-emission signal φIa, a second light-emission signal φIb, a third light-emission signal φIc, a fourth light-emission signal φId and a fifth light-emission signal φIe are shown as the light-emission signals φI. Here, the first light-emission signal φIa is employed when the position correction data set P and the magnification correction data set M are the reference position correction data set P0 and the reference magnification correction data set M0, respectively. Further, the second light-emission signal φIb is employed when the position correction data set P and the magnification correction data set M are the first position correction data set P1 and the reference magnification correction data set M0, respectively. Furthermore, the third light-emission signal φIc is employed when the position correction data set P and the magnification correction data set M are the second position correction data set P2 and the reference magnification correction data set M0, respectively. Furthermore, the fourth light-emission signal φId is employed when the position correction data set P and the magnification correction data set M are the reference position correction data set P0 and the first magnification correction data set M1, respectively. Furthermore, the fifth light-emission signal φIe is employed when the position correction data set P and the magnification correction data set M are the reference position correction data set P0 and the second magnification correction data set M2, respectively.

Note that the timing chart shown in FIG. 12 describes the case where all the light-emitting thyristors L set as luminous points are caused to emit light in the light-emitting chip C. Moreover, assume that, in the initial condition, the start transfer signal φS is set to the low level (L), the first transfer signal φ1 is set to the high level (H), the second transfer signal φ2 is set to the low level, and each of the light-emission signals φI (φIa to φIe) are set to the high level. Here, an operation of one light-emitting chip C will be described, but actually, the light-emitting chips C1 to C60 operate in parallel.

With start of the operation, the start transfer signal φS inputted by the transfer signal generating unit 120 of the signal generating circuit 100 is changed from the low level to the high level. As a result, the start transfer signal φS of high level is supplied to the gate terminal G1 of the transfer thyristor S1 in the light-emitting chip C. In this event, this start transfer signal φS is supplied to the gate terminals G2 to G260 of the other transfer thyristors S2 to S260 through the diodes D1 to D259. However, since each of the diodes D1 to D260 causes a voltage drop, the highest voltage is applied to the gate terminal G1 of the transfer thyristor S1.

Then, in the state where the start transfer signal φS is set to the high level, the first transfer signal φ1 inputted by the transfer signal generating unit 120 is changed from the high level to the low level. After a first period ta passes from when the first transfer signal φ1 is changed to the low level, the second transfer signal φ2 inputted by the transfer signal generating unit 120 is changed from the low level to the high level.

In the light-emitting chip C supplied with the first transfer signal φ1 of low level in the state where the start transfer signal φS is set to the high level as described above, the transfer thyristor S1, which has the highest gate voltage not lower than a threshold, is turned on among the odd-numbered transfer thyristors S1, S3, . . . , S259 that are supplied with the first transfer signal φ1 of low level. Meanwhile, since the second transfer signal φ2 is set to the high level at the same time, the even-numbered transfer thyristors S2, S4, . . . , S260 are kept to have high cathode voltages, and thus kept turned off. Thus, only the odd-numbered transfer thyristor S1 is turned on in the light-emitting chip C. As a result, the light-emitting thyristor L1 whose gate terminal is connected to the gate terminal of the odd-numbered transfer thyristor S1 is turned on to be ready to emit light.

After a second period tb passes from when the second transfer signal φ2 is changed to the high level in the state where the transfer thyristor S1 is turned on, the second transfer signal φ2 is changed from the high level to the low level. In response, the transfer thyristor S2, which has the highest gate voltage not lower than the threshold, is turned on among the even-numbered transfer thyristor S2, S4, . . . , S260 that are supplied with the second transfer signal φ2 of low level. Thus, both the odd-numbered transfer thyristor S1 and the even-numbered transfer thyristor S2 adjacent thereto are turned on in the light-emitting chip C. As a result, in addition to the light-emitting thyristor L1 that has already been turned on, the light-emitting thyristor L2 whose gate terminal is connected to the gate terminal of the even-numbered transfer thyristor S2 is turned on, and these light-emitting thyristors L1 and L2 are both made ready to emit light.

After a third period tc passes from when the second transfer signal φ2 is changed to the low level in the state where both the transfer thyristors S1 and S2 are turned on, the first transfer signal φ1 is changed from the low level to the high level. In response, the odd-numbered transfer thyristor S1 is turned off, and thus only the even-numbered transfer thyristor S2 is turned on. As a result, the odd-numbered light-emitting thyristor L1 is turned off to be disabled to emit light, and only the even-numbered light-emitting thyristor L2 remains turned on to be ready to emit light. Note that, in this example, at the same time as the first transfer signal φ1 is changed to the high level, the start transfer signal φS is changed to the high level to the low level.

After a fourth period td passes from when the first transfer signal φ1 is changed to the high level in the state where the transfer thyristor S2 is turned on, the first transfer signal φ1 is changed from the high level to the low level. In response, the transfer thyristor S3, which has the highest gate voltage, is turned on among the odd-numbered transfer thyristors S1, S3, . . . , S259 that are supplied with the first transfer signal φ1 of low level. Thus, both the even-numbered transfer thyristor S2 and the odd-numbered transfer thyristor S3 adjacent thereto are turned on in the light-emitting chip C. As a result, in addition to the light-emitting thyristor L2 that has already been turned on, the light-emitting thyristor L3 whose gate terminal is connected to the gate terminal of the odd-numbered transfer thyristor S3 is turned on, and these light-emitting thyristors L2 and L3 are both made ready to emit light.

After a fifth period te passes from when the first transfer signal φ1 is changed to the low level in the state where both the transfer thyristors S2 and S3 are turned on, the second transfer signal φ2 is changed from the low level to the high level. In response, the even-numbered transfer thyristor S2 is turned off, and thus only the odd-numbered transfer thyristor S3 is turned on. As a result, the even-numbered light-emitting thyristor L2 is turned off to be disabled to emit light, and only the odd-numbered light-emitting thyristor L3 remains turned on to be ready to emit light.

As described above, the transfer thyristors S1 to S260 are turned on in the numerical order in the light-emitting chip C by alternately switching the first and second transfer signals φ1 and φ2 to either the high level or the low level while interposing an overlapping period where both the first and second transfer signals φ1 and φ2 are set to the low level. In addition, this causes the light-emitting thyristors L1 to L260 to be turned on in the numerical order, too. During this operation, the following process is repeated: firstly, only an odd-numbered transfer thyristor (the transfer thyristor S1, for example) is turned on in the second period tb; secondly, the odd-numbered transfer thyristor and the adjacent even-numbered transfer thyristor labeled with a number larger by one than the odd-numbered transfer thyristor (the transfer thyristors S1 and S2, for example) are turned on in the third period tc; thirdly, only the even-numbered transfer thyristor (the transfer thyristor S2, for example) is turned on in the fourth period td; fourthly, the even-numbered transfer thyristor and the adjacent odd-numbered transfer thyristor labeled with a number larger by one than the even-numbered transfer thyristor (the transfer thyristors S2 and S3, for example) are turned on in the fifth period te; and then only the odd-numbered transfer thyristor (the transfer thyristor S3, for example) is turned on in the second period tb.

Hereinbelow, a description will be given of a light-emitting operation performed by the light-emitting thyristors L1 to L260 in accordance with the first light-emission signal φIa. Basically, the first light-emission signal φIa is changed from the high level to the low level and then from the low level to the high level in each third period tc where a pair of odd- and even-numbered transfer thyristors are both turned on. However, such a change is not made in each of the period where the leftmost two transfer thyristors S1 and S2 are both turned on and the period where the rightmost two transfer thyristors S259 and S260 are both turned on. As a result, pairs of all the light-emitting thyristors in the light-emitting chip C, except ones positioned in the both end portions, L3 and L4, L5 and L6, . . . , L255 and L256, L257 and L258 sequentially emit light.

Next, a description will be given of the light-emitting operation performed by the light-emitting thyristors L1 to L260 in accordance with the second light-emission signal φIb. Basically, the second light-emission signal φIb is changed from the high level to the low level and then from the low level to the high level in each fifth period te where a pair of even- and odd-numbered transfer thyristors is both turned on. However, such a change is not made in the period where the rightmost two transfer thyristors S258 and S259 are both turned on. As a result, pairs of the light-emitting thyristors in the light-emitting chip C, except one positioned in the rightmost portion, L2 and L3, L4 and L5, . . . , L254 and L255, L256 and L257 sequentially emit light.

Next, a description will be given of the light-emitting operation performed by the light-emitting thyristors L1 to L260 in accordance with the third light-emission signal φIc. Basically, the third light-emission signal φIc is changed from the high level to the low level and then from the low level to the high level in each fifth period te where a pair of even- and odd-numbered transfer thyristors is both turned on. However, such a change is not made in the period where the leftmost two transfer thyristors S2 and S3 are both turned on. As a result, pairs of the light-emitting thyristors in the light-emitting chip C, except one positioned in the leftmost portion, L4 and L5, L6 and L7, . . . , L256 and L257, L258 and L259 sequentially emit light.

Next, a description will be given of the light-emitting operation performed by the light-emitting thyristors L1 to L260 in accordance with the fourth light-emission signal φId. Basically, the fourth light-emission signal φId is changed from the high level to the low level and then from the low level to the high level in each third period to where a pair of odd- and even-numbered transfer thyristors is both turned on. However, such a change is not made in each of the period where the leftmost two transfer thyristors S1 and S2 are both turned on and the period where the rightmost two transfer thyristors S259 and S260 are both turned on. In addition, the fourth light-emission signal φId is changed from the high level to the low level and then from the low level to the high level in the second period tb where only the transfer thyristor S259 on the right side is turned on. As a result, pairs of the light-emitting thyristors in the light-emitting chip C, except ones positioned in the both end portions, L3 and L4, L5 and L6, . . . , L255 and L256, L257 and L258 sequentially emit light, and then the light-emitting thyristor L259 emits light alone.

Lastly, a description will be given of the light-emitting operation performed by the light-emitting thyristors L1 to L260 in accordance with the fifth light-emission signal φIe. Basically, the fifth light-emission signal φIe is changed from the high level to the low level and then from the low level to the high level in each third period tc where a pair of odd- and even-numbered transfer thyristors is both turned on. However, such a change is not made in each of the period where the leftmost two transfer thyristors S1 and S2 are both turned on, the period where the two transfer thyristors S257 and S258 on the right side are both turned on, and the period where the rightmost two transfer thyristors S259 and S260 are both turned on. In addition, the fifth light-emission signal φIe is changed from the high level to the low level and then from the low level to the high level in the second period tb where only the transfer thyristor S257 on the right side is turned on. As a result, pairs of all the light-emitting thyristors in the light-emitting chip C, except ones positioned in the both end portions, L3 and L4, L5 and L6, . . . , L255 and L256 sequentially emit light, and then the light-emitting thyristor L257 emits light alone.

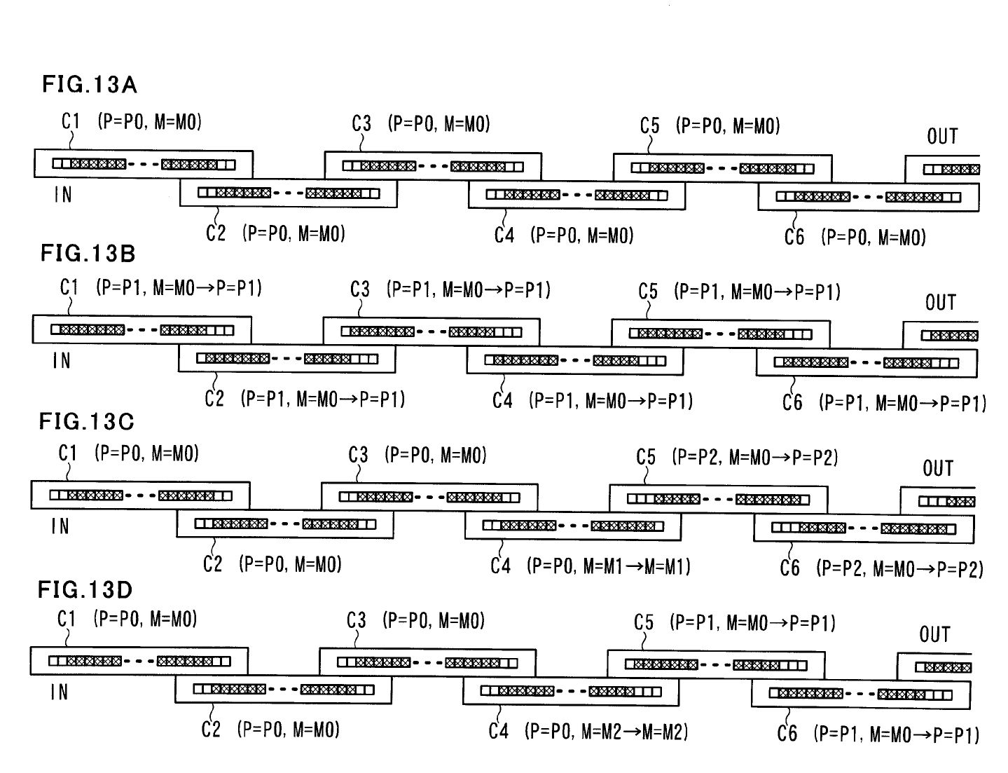

FIGS. 13A to 13D show luminous points of the light-emitting chips C1 to C6 in the LPHs 14 mounted on the image forming apparatus 1 in the condition shown in FIG. 8. Here, FIGS. 13A to 13D show the yellow LPH 14Y, the magenta LPH 14M, the cyan LPH 14C and the black LPH 14K, respectively. Note that, the luminous points of the light-emitting chips C (C1 to C60) constituting each LPH 14 are corrected on the basis of the corresponding ones of the position correction data sets P and the magnification correction data sets M prepared for different colors shown in FIGS. 9A to 9H.

As shown in FIG. 13A, the normal luminous-point group LA is set as the luminous points in each of the light-emitting chips C1 to C60 of the yellow LPH 14Y. This makes the luminous points consecutive in the fast scan direction, in the overlapping portion (see FIG. 4) of each adjacent two of the light-emitting chips C1 to C60.

By contrast, as shown in FIG. 13B, the luminous point group shifted by one luminous point to the IN side with respect to the normal luminous-point group LA is set as the luminous points in each of the light-emitting chips C1 to C60 of the magenta LPH 14M. This corrects the OUT-side positional shift of the magenta LPH 14M shown in FIG. 8 to make the luminous points thereof consistent with those of the yellow LPH 14Y. In this case as well, the luminous points are consecutive in the fast scan direction, in the overlapping portion (see FIG. 4) of each adjacent two of the light-emitting chips C1 to C60.

Meanwhile, in the cyan LPH 14C, the normal luminous-point group LA is set as the luminous points in each of the light-emitting chips C1 to C3, the luminous point group formed of the normal luminous-point group LA and one luminous point added to the OUT side thereof is set as the luminous points in the light-emitting chip C4, and the luminous point group shifted by one luminous point to the OUT side with respect to the normal luminous-point group LA is set as the luminous points in each of the light-emitting chips C5 to C60, as shown in FIG. 13C. This corrects the size-reduction deviation of the cyan LPH 14C shown in FIG. 8 to make the luminous points thereof consistent with those of the yellow LPH 14Y. In this case as well, the luminous points are consecutive in the fast scan direction, in the overlapping portion (see FIG. 4) of each adjacent two of the light-emitting chips C1 to C60. Note that, though the luminous points in light-emitting chip C4 are increased in this example, substantially the same result will be obtained if the luminous points in any one of the light-emitting chips C1 to C60 are increased.

Moreover, in the black LPH 14K, the normal luminous-point group LA is set as the luminous points in each of the light-emitting chips C1 to C3, the normal luminous-point group LA except one luminous point on the OUT side thereof is set as the luminous points in the light-emitting chip C4, and the luminous point group shifted by one luminous point to the IN side with respect to the normal luminous-point group LA is set as the luminous points in each of the light-emitting chips C5 to C60, as shown in FIG. 13D. This corrects the size-enlargement deviation of the black LPH 14K shown in FIG. 8 to make the luminous points thereof consistent with those of the yellow LPH 14Y. In this case as well, the luminous points are consecutive in the fast scan direction, in the overlapping portion (see FIG. 4) of each adjacent two of the light-emitting chips C1 to C60. Note that, though the luminous points in light-emitting chip C4 are reduced in this example, substantially the same result will be obtained if the luminous points in any one of the light-emitting chips C1 to C60 are reduced.

Note that, in the above example, the description has been given of the case where any one of the reference position correction data set P0 or the reference magnification correction data set M0 must be employed in each light-emitting chip C. Thus, neither of the light-emitting thyristors L1 and L260, which are positioned on the IN-side and OUT-side endmost portions of each of the light-emitting chips C1 to C60, are set as luminous points. However, if a combination of: any one of the first and second position data sets P1 and P2; and any one of the first and second magnification correction data sets M1 and M2 is employed in a certain light-emitting chip C, the light-emitting thyristor L1 or L260 may be set as a luminous point.

Alternatively, the image forming apparatus 1 may be configured that any one of the reference position correction data set P0 or the reference magnification correction data set M0 must be employed in each light-emitting chip C, and thus that additional position correction data sets P are employed such that the luminous points may be shifted to the IN side and the OUT side by one more (by up to two).

### Second Exemplary Embodiment

The second exemplary embodiment is basically the same as the first exemplary embodiment, but is different in that magnification correction is achieved not by increasing or reducing the luminous points in each light-emitting chip C but by increasing or reducing light-emission intensities of the light-emitting thyristors L set as the luminous points on end portions of each light-emitting chip C. Note that, in the second exemplary embodiment, the same or similar constituents as the first exemplary embodiment are denoted by the same reference numerals and the detailed description thereof will be omitted.

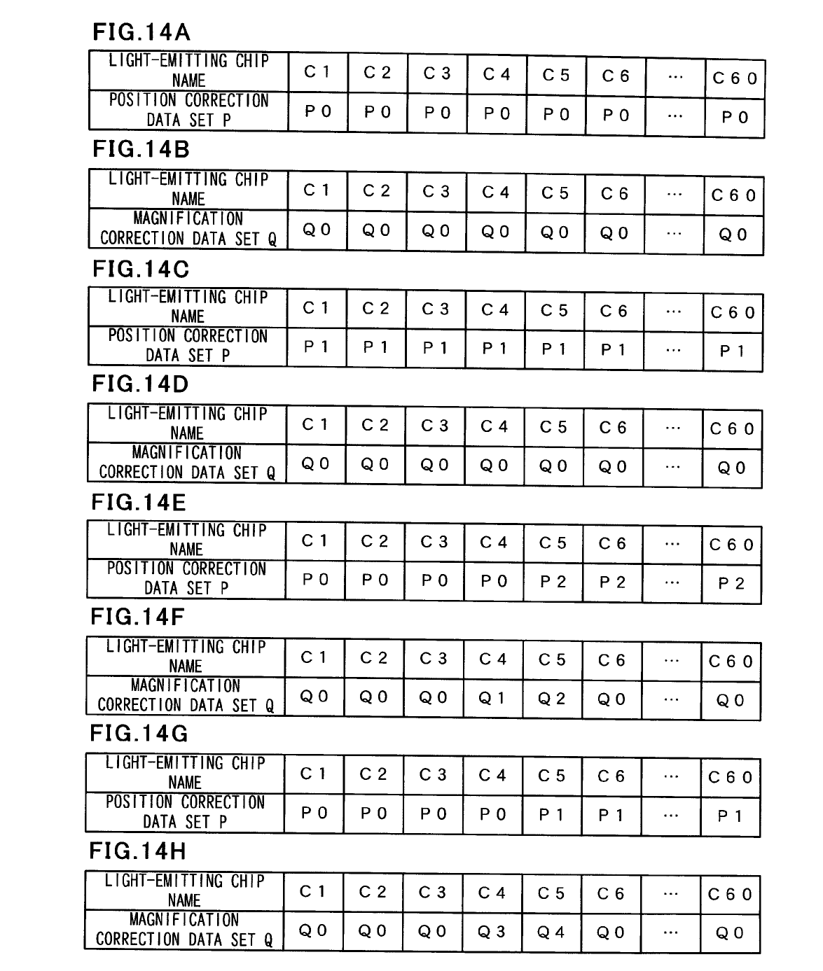

FIGS. 14A, 14C, 14E and 14G are tables for illustrating relationships between light-emitting chip names and position correction data sets P, which are stored in the position correction data memories 112, while FIGS. 14B, 14D, 14F and 14H are tables for illustrating relationships between light-emitting chip names and magnification correction data sets M, which are stored in the magnification correction data memories 113. Here, the position correction data memory 112 and the magnification correction data memory 113 are provided in each LPH 14. Similarly to the first exemplary embodiment, FIGS. 14A to 14H show various correction data sets to be set when the yellow LPH 14Y, the magenta LPH 14M, the cyan LPH 14C and the black LPH 14K are mounted in the image forming apparatus 1 in the condition shown in FIG. 8.

Here, FIGS. 14A and 14B show contents stored in the position correction data memory 112 and the magnification correction data memory 113 of the yellow LPH 14Y, respectively. FIGS. 14C and 14D show contents stored in the position correction data memory 112 and the magnification correction data memory 113 of the magenta LPH 14M, respectively. FIGS. 14E and 14F show contents stored in the position correction data memory 112 and the magnification correction data memory 113 of the cyan LPH 14C, respectively. FIGS. 14G and 14H show contents stored in the position correction data memory 112 and the magnification correction data memory 113 of the black LPH 14K, respectively. Note that position correction data sets P shown in each of FIGS. 14A, 14C, 14E and 14G are the same as those explained in the first exemplary embodiment (shown in each of FIGS. 9A, 9C, 9E and 9G).

As shown in FIG. 14B, in the magnification correction data memory 113 of the yellow LPH 14Y, a reference magnification correction data set Q0 is set for the respective light-emitting chips C1 to C60. As shown in FIG. 14D, in the magnification correction data memory 113 of the magenta LPH 14M, the reference magnification correction data set Q0 is set for the respective light-emitting chips C1 to C60. As shown in FIG. 14F, in the magnification correction data memory 113 of the cyan LPH 14C, the reference magnification correction data set Q0 is set for the respective light-emitting chips C1 to C3 and C6 to C60, a first magnification correction data set Q1 is set for the light-emitting chip C4, and a second magnification correction data set Q2 is set for the light-emitting chip C5. As shown in FIG. 14H, in the magnification correction data memory 113 of the black LPH 14K, the reference magnification correction data set Q0 is set for the respective light-emitting chips C1 to C3 and C6 to C60, a third magnification correction data set Q3 is set for the light-emitting chip C4, and a fourth magnification correction data set Q4 is set for the light-emitting chip C5.

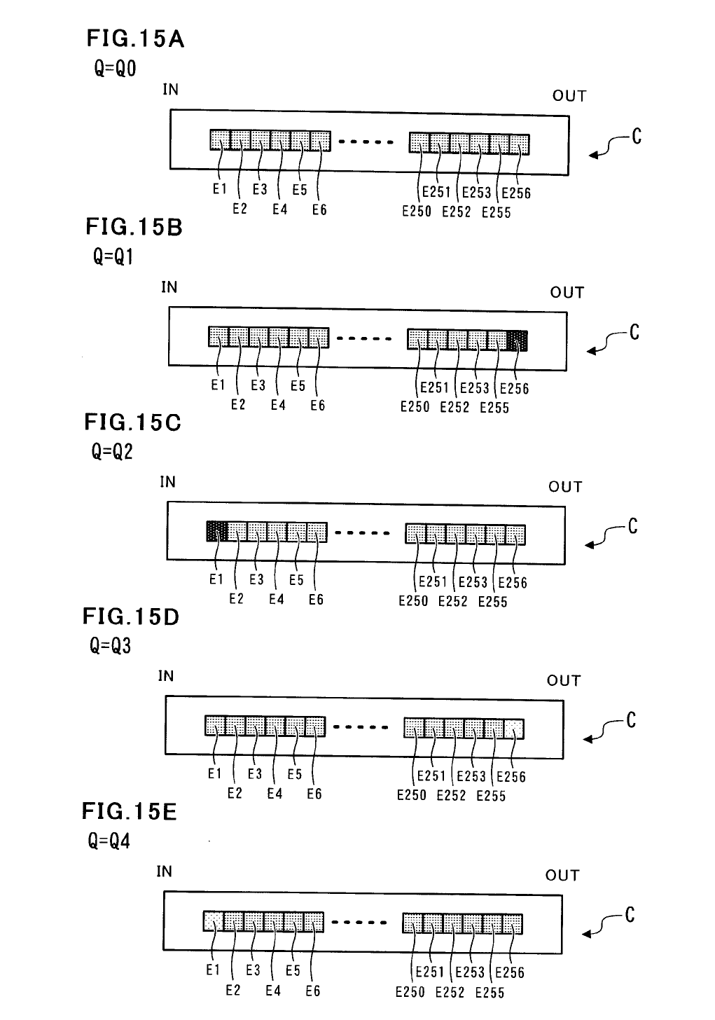

FIGS. 15A to 15E are diagrams each for illustrating a relationship between the magnification correction data set Q and light intensities of the luminous points in each light-emitting chip C caused by magnification correction. As described above, the magnification correction data set Q may be the reference magnification correction data set Q0, the first magnification correction data set Q1, the second magnification correction data set Q2, the third magnification correction data set Q3 or the fourth magnification correction data set Q4. Here, FIGS. 15A to 15E show the cases of Q=Q0, Q=Q1, Q=Q2, Q=Q3 and Q=Q4, respectively. Note that the number of luminous points in each light-emitting chip C is constant (256) irrespective of presence or absence of magnification correction, in the second exemplary embodiment. Thus, the luminous points of each light-emitting chip C will be referred to as luminous points E1 to E256 in the following description.

As shown in FIG. 15A, with Q=Q0, the luminous points E1 to E256 are set to have an equal light intensity. By contrast, with Q=Q1, though the luminous points E1 to E255 are set to have an equal light intensity, the OUT-side endmost luminous point E256 is set to have an light intensity higher than the other luminous points E1 to E255. Meanwhile, with Q=Q2, the luminous points E2 to E256 are set to have an equal light intensity, and the IN-side endmost luminous point E1 is set to have an light intensity higher than the other luminous points E2 to E256. With Q=Q3, the luminous points E1 to E255 are set to have an equal light intensity, and the OUT-side endmost luminous point E256 is set to have an light intensity lower than the other luminous points E1 to E255. With Q=Q4, the luminous points E2 to E256 are set to have an equal light intensity, and the IN-side endmost luminous point E1 is set to have an light intensity lower than the other luminous points E2 to E256.

In the second exemplary embodiment, the light-emission intensity of each of the light-emitting thyristors L1 to L260 is controlled by adjusting the length of the period (light emission period) where the light-emission signal φI remains set to the low level while the corresponding one of the transfer thyristors S1 to S260 is turned on. Specifically, in order to reduce a light intensity, the corresponding light emission period is set shorter than a reference light emission period that is predefined to achieve a reference light intensity. On the other hand, in order to increase a light intensity, the corresponding light emission period is set longer than the reference light emission period.

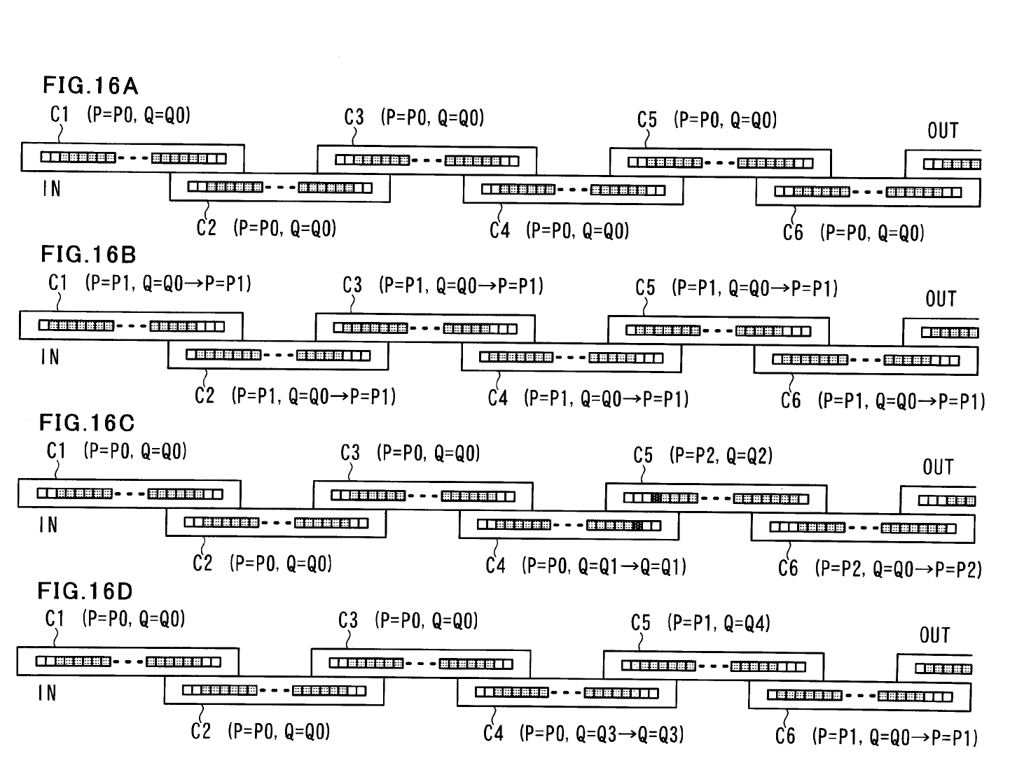

FIGS. 16A to 16D show luminous points of the light-emitting chips C1 to C6 in the LPHs 14 mounted on the image forming apparatus 1 in the condition shown in FIG. 8. Here, FIGS. 16A to 16D show the yellow LPH 14Y, the magenta LPH 14M, the cyan LPH 14C and the black LPH 14K, respectively. Note that, the luminous points of the light-emitting chips C (C1 to C60) constituting each LPH 14 are corrected based on the corresponding ones of the position correction data sets P and the magnification correction data sets Q prepared for different colors, and shown in FIGS. 14A to 14H.

As shown in FIG. 16A, the normal luminous-point group LA is set as the luminous points in each of the light-emitting chips C1 to C60 of the yellow LPH 14Y. This makes the luminous points consecutive in the fast scan direction, in the overlapping portion (see FIG. 4) of each adjacent two of the light-emitting chips C1 to C60.

By contrast, as shown in FIG. 16B, the luminous point group shifted by one luminous point to the IN side with respect to the normal luminous-point group LA is set as the luminous points in each of the light-emitting chips C1 to C60 of the magenta LPH 14M. This corrects the OUT-side positional shift of the magenta LPH 14M shown in FIG. 8 to make the luminous points thereof consistent with those of the yellow LPH 14Y. In this case as well, the luminous points are consecutive in the fast scan direction, in the overlapping portion (see FIG. 4) of each adjacent two of the light-emitting chips C1 to C60.

Meanwhile, in the cyan LPH 14C, the normal luminous-point group LA is set as the luminous points in each of the light-emitting chips C1 to C4, and the luminous point group shifted by one luminous point to the OUT side with respect to the normal luminous-point group LA is set as the luminous points in each of the light-emitting chips C5 to C60, as shown in FIG. 16C. In this case, the luminous points are consecutive in the fast scan direction, in the overlapping portion of each adjacent two of the light-emitting chips C1 to C4 and each adjacent two of the light-emitting chips C5 to C60. By contrast, the overlapping portion of the light-emitting chips C4 and C5 lacks one luminous point necessary for the luminous points to be consecutive in the fast scan direction. However, in the overlapping portion of the light-emitting chips C4 and C5, the light intensities of the light-emitting thyristor L258 to serve as the OUT-side endmost luminous point of the light-emitting chip C4 and the light-emitting thyristor L4 to serve as the IN-side endmost luminous point of the light-emitting chip C5 are increased. This minimizes the appearance of stripes in an electrostatic latent image formed on the corresponding photoconductor drum 12 caused by the inconsecutiveness of the luminous points in the fast scan direction. Specifically, the stripes appear as white stripes when reversal development is employed but appear as black stripes when charged area development is employed. This corrects the size-reduction deviation of the cyan LPH 14C shown in FIG. 8 to make the luminous points thereof consistent with those of the yellow LPH 14Y. Note that, though the light intensities are adjusted in the overlapping portion of the light-emitting chips C4 and C5 in this example, substantially the same result will be obtained if light intensities are adjusted in the overlapping portion of any other two adjacent light-emitting chips C.

Moreover, in the black LPH 14K, the normal luminous-point group LA is set as the luminous points in each of the light-emitting chips C1 to C4, and the luminous point group shifted by one luminous point to the IN side with respect to the normal luminous-point group LA is set as the luminous points in each of the light-emitting chips C5 to C60, as shown in FIG. 16D. In this case, the luminous points are consecutive in the fast scan direction, in the overlapping portion of each adjacent two of the light-emitting chips C1 to C4 and each adjacent two of the light-emitting chips C5 to C60. By contrast, in the overlapping portion of the light-emitting chips C4 and C5, two luminous points overlap in the fast scan direction. However, in the overlapping portion of the light-emitting chips C4 and C5, the light intensities of the light-emitting thyristor L258 to serve as the OUT-side endmost luminous point of the light-emitting chip C4 and the light-emitting thyristor L2 to serve as the IN-side endmost luminous point of the light-emitting chip C5 are reduced. This minimizes the appearance of stripes in an electrostatic latent image formed on the corresponding photoconductor drum 12 caused by the overlapping of the luminous points in the fast scan direction. Specifically, the stripes appear as black stripes when reversal development is employed but appear as white stripes when charged area development is employed. This corrects the size-enlargement deviation of the black LPH 14K shown in FIG. 8 to make the luminous points thereof consistent with those of the yellow LPH 14Y. Note that, though the light intensities are adjusted in the overlapping portion of the light-emitting chips C4 and C5 in this example, substantially the same result will be obtained if light intensities are adjusted in the overlapping portion of any other two adjacent light-emitting chips C.

Here, in the first and second exemplary embodiments, while each LPH 14 has the output resolution of 1200 dpi, a video data set Vdata has a resolution of 600 dpi, which is half (½) of the output resolution of each LPH 14. However, the resolution of the video data set Vdata is not limited to this, but may be 1/m (m is an integer of 2 or more) of the output resolution of the LPH 14. In this case, each pixel may be formed of m continuous light-emitting thyristors L.

### Third Exemplary Embodiment

The third exemplary embodiment is basically the same as the first exemplary embodiment, but is different from the first exemplary embodiment in that each LPH 14 having an output resolution of 1200 dpi is driven by using a video data set Vdata having a resolution of 1200 dpi instead of a video data set Vdata having a resolution of 600 dpi. Note that, in the third exemplary embodiment, the same or similar constituents as the first exemplary embodiment are denoted by the same reference numerals and the detailed description thereof will be omitted.

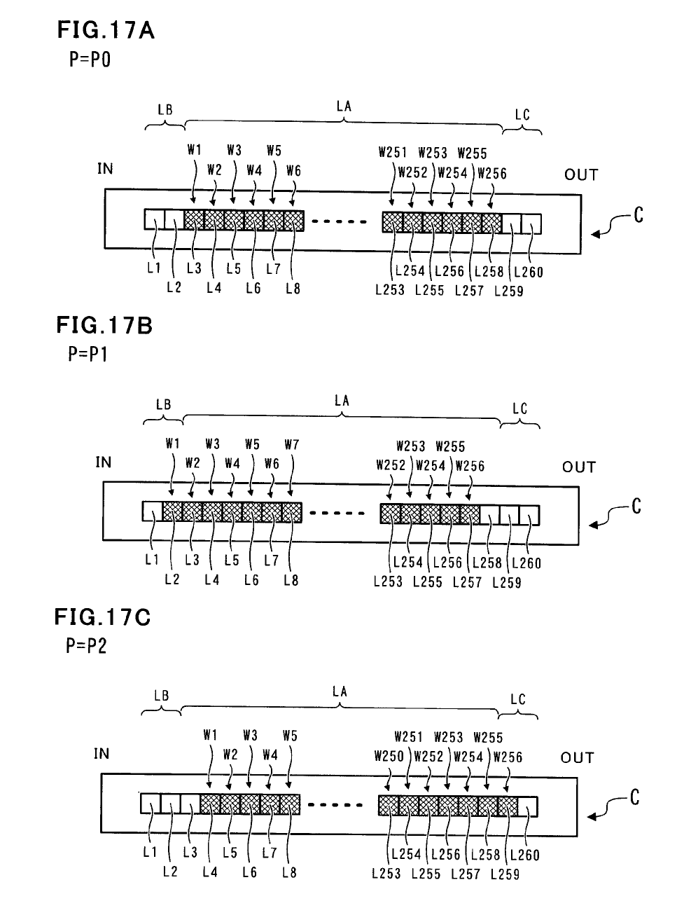

FIGS. 17A to 17C are diagrams each for illustrating a relationship between the position correction data set shown in FIG. 9 and changes in luminous points in each light-emitting chip C caused by position correction. Here, the position correction data set maybe the reference position correction data set P0, the first position correction data set P1 or the second position correction data set P2. Here, FIGS. 17A to 17C show the cases of P=P0, P=P1 and P=P2, respectively.

As shown in FIG. 17A, with P=P0, the normal luminous-point group LA, that is, the light-emitting thyristors L3 to L258 remain set as the luminous points in the light-emitting chip C. As a result, the light-emitting chip C forms 256 pixels W1 to W256 by using the 256 light-emitting thyristors L3 to L258. Specifically, the pixel W1 on the left side of FIG. 17A is formed of the light-emitting thyristor L3, while the pixel W256 on the right side of FIG. 17A is formed of the light-emitting thyristor L258, for example.

By contrast, as shown in FIG. 17B, with P=P1, the luminous points in the light-emitting chip C are set to the light-emitting thyristors L2 to L257, and thus the luminous points shift by one to the IN side. As a result, the light-emitting chip C forms the 256 pixels W1 to W256 by using the 256 light-emitting thyristors L2 to L257. Specifically, the pixel W1 on the left side of FIG. 17B is formed of the light-emitting thyristor L2, while the pixel W256 on the right side of FIG. 17B is formed of the light-emitting thyristor L257, for example.

On the other hand, as shown in FIG. 17C, with P=P2, the luminous points in the light-emitting chip C are set to the light-emitting thyristors L4 to L259, and thus the luminous points shift by one to the OUT side. As a result, the light-emitting chip C forms the 256 pixels W1 to W256 by using the 256 light-emitting thyristors L4 to L259. Specifically, the pixel W1 on the left side of FIG. 17C is formed of the light-emitting thyristor L4, while the pixel W256 on the right side of FIG. 17C is formed of the light-emitting thyristor L259, for example.

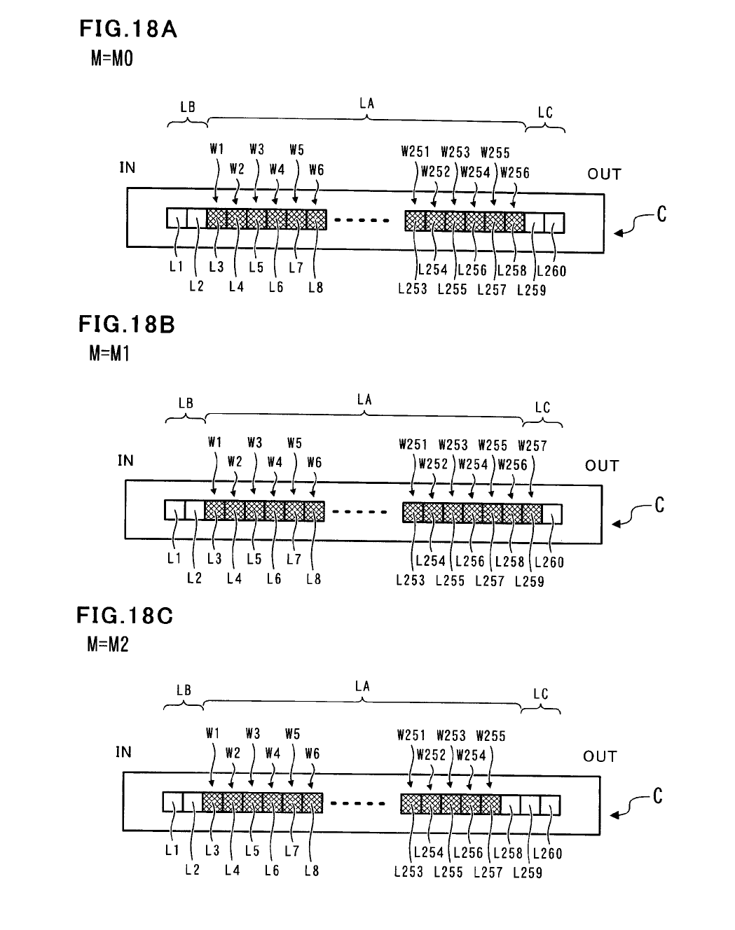

FIGS. 18A to 18C are diagrams each for illustrating a relationship between the magnification correction data set shown in FIG. 9 and changes in luminous points in each light-emitting chip C caused by magnification correction. Here, the magnification correction data set may be the reference magnification correction data set M0, the first magnification correction data set M1 or the second magnification correction data set M2. Here, FIGS. 18A to 18C show the cases of M=M0, M=M1 and M=M2, respectively.

As shown in FIG. 18A, with M=M0, the normal luminous-point group LA, that is, the light-emitting thyristors L3 to L258 remain set as the luminous points in the light-emitting chip C. As a result, the light-emitting chip C forms 256 pixels W1 to W256 by using the 256 light-emitting thyristors L3 to L258.

By contrast, as shown in FIG. 18B, with M=M1, the luminous points in the light-emitting chip C are set to the light-emitting thyristors L3 to L259, and thus the luminous points increases by one on the right side of FIG. 18B (on the OUT side in FIG. 8). As a result, the light-emitting chip C forms the 257 pixels W1 to W257 by using the 257 light-emitting thyristors L3 to L259. Specifically, the pixel W1 on the left side of FIG. 18B is formed of the light-emitting thyristor L3, while the pixel W257 on the right side of FIG. 18B is formed of the light-emitting thyristor L259, for example.

On the other hand, as shown in FIG. 18C, with M=M2, the luminous points in the light-emitting chip C are set to the light-emitting thyristors L3 to L257, and thus the luminous points decreases by one on the left side of FIG. 18C (on the IN side in FIG. 8). As a result, the light-emitting chip C forms the 255 pixels W1 to W255 by using the 255 light-emitting thyristors L3 to L257. Specifically, the pixel W1 on the left side of FIG. 18C is formed of the light-emitting thyristor L3, while the pixel W255 on the right side of FIG. 18C is formed of the light-emitting thyristor L257, for example.

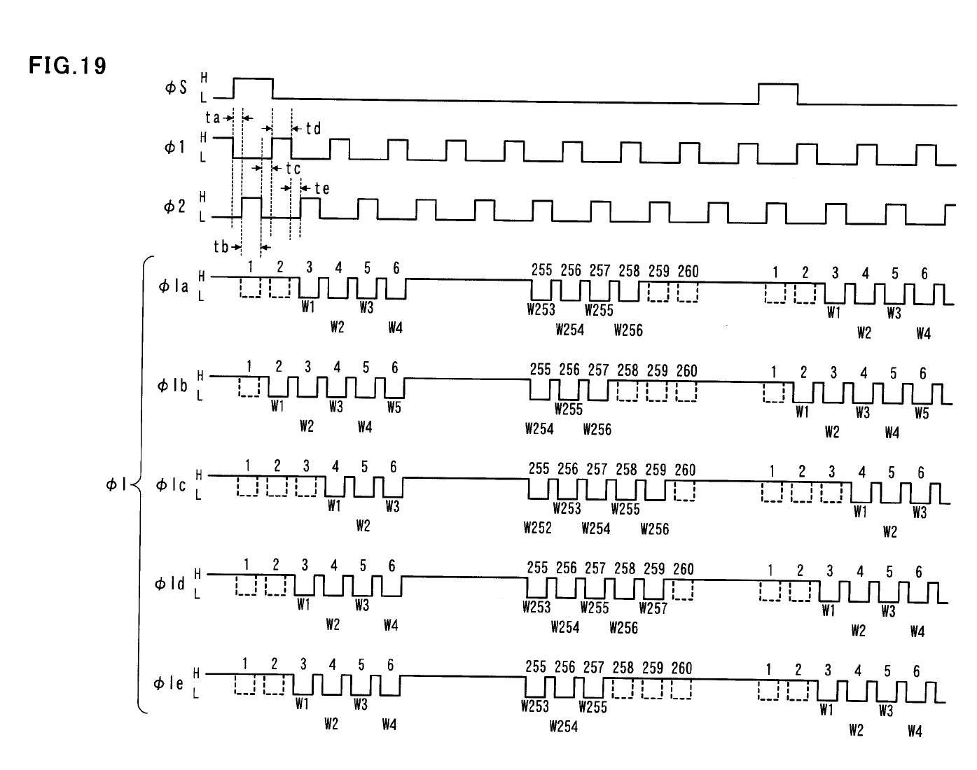

FIG. 19 is a timing chart for illustrating how each light-emitting chip C operates during the exposure operation in the third exemplary embodiment. Note that the waveforms of the start transfer signal φS, the first transfer signal φ1 and the second transfer signal φ2 are the same as those in the first exemplary embodiment, respectively.

Hereinbelow, a description will be given of the light-emitting operation performed by the light-emitting thyristors L1 to L260 in accordance with the first light-emission signal φIa. Note that, as in the first exemplary embodiment, the first light-emission signal φIa is employed when the position correction data set P and the magnification correction data set M are the reference position correction data set P0 and the reference magnification correction data set M0, respectively. Basically, the first light-emission signal φIa is changed from the high level to the low level and then from the low level to the high level in each of the second periods tb and the fourth periods td. Here, the second period tb is a period where an odd-numbered transfer thyristor is turned on alone, while the fourth period td is a period where an even-numbered transfer thyristor is turned on alone. However, such a change is not made in each of the periods where the leftmost two transfer thyristors S1 and S2 and the rightmost two transfer thyristors S259 and S260 are respectively turned on. As a result, the light-emitting thyristors L3, L4, . . . , L257, L258 in the light-emitting chip C sequentially emit light one by one.

Next, a description will be given of the light-emitting operation performed by the light-emitting thyristors L1 to L260 in accordance with the second light-emission signal φIb. As in the first exemplary embodiment, the second light-emission signal φIb is employed when the position correction data set P and the magnification correction data set M are the first position correction data set P1 and the reference magnification correction data set M0, respectively. Basically, the second light-emission signal φIb is changed from the high level to the low level and then from the low level to the high level in each of the second periods tb and the fourth periods td. Here, the second period tb is a period where an odd-numbered transfer thyristor is turned on alone, while the fourth period td is a period where an even-numbered transfer thyristor is turned on alone. However, such a change is not made in each of the periods where the leftmost one transfer thyristor S1 and the rightmost three transfer thyristors S258 to S260 are respectively turned on. As a result, the light-emitting thyristors L2, L3, . . . , L256, L257 in the light-emitting chip C sequentially emit light one by one.

Further, a description will be given of the light-emitting operation performed by the light-emitting thyristors L1 to L260 in accordance with the third light-emission signal φIc. As in the first exemplary embodiment, the third light-emission signal φIc is employed when the position correction data set P and the magnification correction data set M are the second position correction data set P2 and the reference magnification correction data set M0, respectively. Basically, the third light-emission signal φIc is changed from the high level to the low level and then from the low level to the high level in each of the second periods tb and the fourth periods td. Here, the second period tb is a period where an odd-numbered transfer thyristor is turned on alone, while the fourth period td is a period where an even-numbered transfer thyristor is turned on alone. However, such a change is not made in each of the periods where the leftmost three transfer thyristors S1 to S3 and the rightmost one transfer thyristor S260 are respectively turned on. As a result, the light-emitting thyristors L4, L5, . . . , L258, L259 in the light-emitting chip C sequentially emit light one by one.

Furthermore, a description will be given of the light-emitting operation performed by the light-emitting thyristors L1 to L260 in accordance with the fourth light-emission signal φId. As in the first exemplary embodiment, the fourth light-emission signal φId is employed when the position correction data set P and the magnification correction data set M are the reference position correction data set P0 and the first magnification correction data set M1, respectively. Basically, the fourth light-emission signal φId is changed from the high level to the low level and then from the low level to the high level in each of the second periods tb and the fourth periods td. Here, the second period tb is a period where an odd-numbered transfer thyristor is turned on alone, while the fourth period td is a period where an even-numbered transfer thyristor is turned on alone. However, such a change is not made in each of the periods where the leftmost two transfer thyristors S1 and S2 and the rightmost one transfer thyristor S260 are respectively turned on. As a result, the light-emitting thyristors L3, L4, . . . , L258, L259 in the light-emitting chip C sequentially emit light one by one. Note that, whether the light-emitting thyristor L259 is permitted to emit light is determined by whether the adjacent light emitting thyristor L258 is permitted to emit light. Specifically, if the light-emitting thyristor L258 is caused to emit light, the light-emitting thyristor L259 is also caused to emit light. By contrast, if the light-emitting thyristor L258 is caused not to emit light, the light-emitting thyristor L259 is also caused not to emit light.

Lastly, a description will be given of the light-emitting operation performed by the light-emitting thyristors L1 to L260 in accordance with the fifth light-emission signal φIe. As in the first exemplary embodiment, the fifth light-emission signal φIe is employed when the position correction data set P and the magnification correction data set M are the reference position correction data set P0 and the second magnification correction data set M2, respectively. Basically, the fifth light-emission signal φIe is changed from the high level to the low level and then from the low level to the high level in each of the second periods tb and the fourth periods td. Here, the second period tb is a period where an odd-numbered transfer thyristor is turned on alone, while the fourth period td is a period where an even-numbered transfer thyristor is turned on alone. However, such a change is not made in each of the periods where the leftmost two transfer thyristors S1 and S2 and the rightmost three transfer thyristors S258 to S260 are respectively turned on. As a result, the light-emitting thyristors L3, L4, . . . , L256, L257 in the light-emitting chip C sequentially emit light one by one.

In the third exemplary embodiment as well, relative positional shifts and magnification deviations of the LPHs 14 are corrected while the consecutiveness of the luminous points in the fast scan direction is maintained in each LPH 14.

In the first to third exemplary embodiments, the anode terminals of the respective transfer thyristors S1 to S260 in each light-emitting chip C are set to have the same electronic potential to one another, while the cathode terminals thereof are set to have different electronic potentials depending on whether the first transfer signal φ1 or the second transfer signal φ2 is supplied thereto. However, the electronic potential setting of the transfer thyristors S1 to S260 is not limited to this, but the cathode terminals of the respective transfer thyristors S1 to S260 are set to have the same electronic potential to one another, while the anode terminals thereof are set to have different electronic potentials depending on whether the first transfer signal φ1 or the second transfer signal φ2 is supplied thereto.

Moreover, in the first to third exemplary embodiments, the anode terminals of the respective light-emitting thyristors L1 to L260 are set to have the same electronic potential to one another, while the cathode terminals thereof are set to have different electronic potentials in response to the light-emission signals φI (φI1 to φI60). However, the electronic potential setting of the light-emitting thyristors L1 to L260 is not limited to this, but the cathode terminals of the respective light-emitting thyristors L1 to L260 are set to have the same electronic potential to one another, while the anode terminals thereof are set to have different electronic potentials in response to the light-emission signals φI.

Furthermore, the first to third exemplary embodiments have been described by taking the case where what is termed as a self-scanning light-emitting chip is employed as each light-emitting chip C, for example. Here, the light-emitting chip C is provided with the light-emitting element array 71 including multiple light-emitting thyristors L, and the switch element array 72 including multiple transfer thyristors. However, the configuration of the light-emitting chip C is not limited to this, but may include multiple light-emitting diodes and multiple switch elements used for switching the corresponding light-emitting diodes between a conductive mode and a non-conductive mode. In other words, the light-emitting chip C has only to include multiple light-emitting elements and one or more switch elements used to cause these light-emitting elements to emit light or not to emit light.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A light-emitting device comprising:
a light-emitting element array that has a plurality of light-emitting elements arrayed in a line at intervals corresponding to a first resolution;
a supply unit that supplies a light-emission signal corresponding to a second resolution, the second resolution being 1/m of the first resolution, where m is an integer not less than 2;
a setting unit that divides the plurality of light-emitting elements into a plurality of sets each including m continuous light-emitting elements in the light-emitting element array, and that sets whether to cause the m continuous light-emitting elements, which are included in each of the plurality of sets, to emit light on a single set basis by using the light-emission signal supplied from the supply unit; and
a correcting unit that corrects the division of the plurality of light-emitting elements in the light-emitting element array performed by the setting unit, on a single light-emitting element basis.

2. The light-emitting device according to claim 1, wherein the correcting unit corrects the division of the plurality of light-emitting elements as a reference by shifting each of the m continuous light-emitting elements by n light-emitting elements in any one of array directions of the plurality of light-emitting elements, where n is an integer of not less than 1.

3. The light-emitting device according to claim 1, wherein the correcting unit corrects the division of the plurality of light-emitting elements as a reference by increasing or reducing, from m, the number of light-emitting elements constituting one of the plurality of sets.

4. An exposure device comprising:
a light-emitting element chip including a substrate, and a light-emitting element array having a plurality of light-emitting elements arrayed in a line in a fast scan direction on the substrate, the light-emitting element array having:
a first light-emitting element group including light-emitting elements arrayed in a center portion in the fast scan direction;
a second light-emitting element group including light-emitting elements arrayed from one end side of the first light-emitting element group in the fast scan direction; and
a third light-emitting element group including light-emitting elements arrayed from the other end side of the first light-emitting element group in the fast scan direction;
a mounting member to which a plurality of the light-emitting element chips are mounted in a zigzag pattern to form an overlapping portion in a borderline region between each adjacent two light-emitting chips, the overlapping portion including the second light-emitting element group in one of the adjacent two light-emitting chips and the third light-emitting element group of the other one of the adjacent two light-emitting chips overlapping with each other in the fast scan direction;
a supply section that supplies a light-emission signal to each of the plurality of light-emitting element chips, the light-emission signal setting, as luminous targets, light-emitting elements being consecutive in the fast scan direction, and being less than the plurality of light-emitting elements constituting the light-emitting element array;
a correcting section that corrects at least any one of positions and the number of the light-emitting elements set as the luminous targets in each of the plurality of light-emitting element chips; and
an optical member that focuses light emitted by the plurality of light-emitting element chips onto an image carrier.

5. The exposure device according to claim 4, wherein the supply section supplies the light-emission signal to each of the plurality of light-emitting element chips so that the light-emitting elements set as the luminous targets are consecutive in the fast scan direction in each overlapping portion.

6. The exposure device according to claim 4, wherein the supply section reduces a light-emission intensity of each of two light-emitting elements set as the luminous targets in the overlapping portion if the two light-emitting elements overlap with each other in the fast scan direction.

7. The exposure device according to claim 4, wherein the supply section increases a light-emission intensity of each of two light-emitting elements set as the luminous targets in the overlapping portion if the two light-emitting elements are inconsecutive in the fast scan direction.

8. An image forming apparatus comprising a plurality of image forming parts each including:
an image carrier,
a charging device that charges the image carrier,
an exposure device that exposes the image carrier charged by the charging device to form an electrostatic latent image on the image carrier, the exposure device including:
a light-emitting element array that has a plurality of light-emitting elements arrayed in a line at intervals corresponding to a first resolution;
a supply unit that supplies a light-emission signal corresponding to a second resolution, the second resolution being 1/m of the first resolution, where m is an integer not less than 2;
a setting unit that divides the plurality of light-emitting elements into a plurality of sets each including m continuous light-emitting elements in the light-emitting element array, and that sets whether to cause the m continuous light-emitting elements, which are included in each of the plurality of sets, to emit light on a single set basis by using the light-emission signal supplied from the supply unit; and
a correcting unit that corrects the division of the plurality of light-emitting elements in the light-emitting element array performed by the setting unit, on a single light-emitting element basis;
a developing device that develops the electrostatic latent image formed on the image carrier to form an image on the image carrier; and
a transfer device that transfers the image formed on the image carrier onto a recording medium.

9. A light-emission control method of a light-emitting device including a light-emitting element array that has a plurality of light-emitting elements arrayed in a line at intervals corresponding to a first resolution; the light-emission control method comprising:
supplying a light-emission signal corresponding to a second resolution, the second resolution being 1/m of the first resolution, where m is an integer not less than 2;
dividing the plurality of light-emitting elements into a plurality of sets each including m continuous light-emitting elements in the light-emitting element array, and setting whether to cause the m continuous light-emitting elements, which are included in each of the plurality of sets, to emit light on a single set basis by using the light-emission signal; and
correcting the division of the plurality of light-emitting elements in the light-emitting element array, on a single light-emitting element basis.
